(19) United States
(12) Patent Application Publication
(10) Pub. No.: US 2026/0111996 A1
(43) Pub. Date: Apr. 23, 2026

(54) ADAPTIVE ARRAY FOR IMAGES GENERATED BY COVARIANT WAVENUMBER-MIGRATION

(71) Applicant: Georgia Tech Research Corporation, Atlanta, GA (US)

(72) Inventors: Quentin Truncale, Atlanta, GA (US); Christopher Barnes, Atlanta, GA (US)

(21) Appl. No.: 19/365,938

(22) Filed: Oct. 22, 2025

Related U.S. Application Data
(60) Provisional application No. 63/710,438, filed on Oct. 22, 2024.

(51) Int. Cl. G06T 5/10; G06T 5/20

(52) U.S. Cl. CPC G06T 5/10; G06T 5/20

(57) ABSTRACT

The present disclosure provides a system for generating interference-mitigated images of a scene within a sensed field of view. The system comprises a sensor array comprising a plurality of sensor elements configured to transmit a waveform and receive corresponding echo and interference signals. The system comprises an adaptation device configured to receive data acquired by the sensor array, estimate or determine characteristics of interference within the received data, and mitigate the interference to generate interference-mitigated data. The system comprises a processor configured to reconstruct one-dimensional, two-dimensional, or three-dimensional images of the sensed field of view by performing Fresnel-based imaging operations on the interference-mitigated data. The data acquired by the sensor array is from transmission of a single pulse or a plurality of pulses, or corresponds to motion of the sensor array.

### CROSS-REFERENCE TO RELATED APPLICATIONS

This application claims the benefit of U.S. Provisional Application Ser. No. 63/710,438, filed on 22 Oct. 2024, which is incorporated herein by reference in its entirety as if fully set forth below.

### FIELD OF INVENTION

The present disclosure relates to systems that include sensor arrays for acquiring data and processing signals to form one-dimensional, two-dimensional, or three-dimensional images of scene content within a sensed field of view, and more particularly to a system, method, and non-transitory computer-readable medium for generating interference-mitigated images using adaptive processing methods for interference mitigation and image formation in fields of view that may be near or far from the sensor array, with the sensor array either stationary or moving.

### BACKGROUND

Conventionally, sensor arrays are utilized for both transmission and reception of electromagnetic or acoustic energy. During transmission, the sensor elements of a sensor array may be driven with controlled phase and amplitude relationships to form a directed beam, thereby concentrating signal energy within a desired spatial region. During reception, sensor arrays may be configured to reconstruct an image or representation of scene content located within the sensor array's field of view (FoV) in one, two, or three spatial dimensions. The magnitude and spatial coordinates of each image element, or pixel, correspond, respectively, to the relative reflectivity and position of an object within the FoV. As used herein, the term “scatterer” refers to a point or localized feature within the FoV that reflects transmitted signal energy toward the sensor array. Prior art produces images from a sensor array using reference Fresnel fields, inverse Huygens-Fresnel transforms, and wavenumber migration techniques. These techniques include steps for generating reference fields based on sensor and scene geometry, performing Fourier transforms, applying Fresnel transfer functions, and reconstructing images of subscenes or full scenes. This approach provides improved cross-range resolution with fewer pulses and grants flexibility for near-range and far-range imaging, but assumes that the received data is free from substantial interference. Sensor arrays often operate in contested environments with varying sources of interference. Electromagnetic interference may arise from multiple sources including, but not limited to, multipath propagation, clutter, co-channel transmissions, active jamming, and cell sites. Traditional sensor arrays capable of generating images from a single pulse of data using Fresnel-based approaches are not designed to mitigate such interference. When jamming is present, resulting images may exhibit elevated noise floors, false objects, reduced contrast, and/or obfuscation of scene content.

Prior art techniques that employ Fraunhofer plane wave approximations may adjust the array pattern of the sensor array in the “far-field” to mitigate interference. The “far-field” of an array represents a distance from the array where the wave front received by the array is nearly planar with respect to the distance to the field of view. This conventional plane wave approach is synonymous with Fraunhofer plane wave beams that exist only at far-field distances. One conventional Fraunhofer-based interference mitigation technique includes the calculation of adaptive steering vectors used to place nulls in the array pattern corresponding to an Angle-of-Arrival (AoA) from the sensor array to the interference source(s). Another conventional Fraunhofer-based interference mitigation technique employs beamspace techniques that use canceller channels to mitigate interference. But there remains a need for means and methods of processing of sensor array data that incorporates interference mitigation techniques directly into Fresnel-based imaging pipelines. A suite of approaches that employ Fresnel wave field assumptions to mitigate interference sources would satisfy such a need. Such a system would be capable of dynamically mitigating interference signals while preserving higher order spherical characteristics associated with Fresnel wave fields. By including interference mitigation into the Fresnel wave-field imaging architecture, it becomes possible to produce interference-mitigated images with a single pulse of data in the sensor array's near-field or far-field for contested environments.

Prior art Fraunhofer plane wave techniques that mitigate interference sources arising in the mainlobe of the array pattern may negatively impact the sensor array's ability to estimate the position of scatterers within the far-field. There is a need for sensor arrays to mitigate interference using Fresnel wave field imaging approaches such that estimation of scatterer location, in the near-field or far-field, is not biased. Adaptive sensor arrays that employ Fresnel wave field techniques to mitigate interference and generate images of the resulting field of view would satisfy such a need.

Fraunhofer-based sensor array interference mitigation techniques place nulls in the array pattern to mitigate interference arriving from a given Angle-of-Arrival using plane wave assumptions. These methods are only applicable in the far-field, do not directly invert waveform propagation to construct an image representative of scatterer reflectivity in a corresponding field of view, and bias scatterer location estimates under conditions of intra-mainlobe interference mitigation. Fresnel field imaging solutions are applicable in both the near-field and far-field of a sensor array, but lack the interference mitigation capacity of Fraunhofer plane wave techniques. Fresnel-based interference mitigation techniques that are applicable in both the near-field and far-field, directly construct an image representative of scatterer reflectivity in a corresponding field of view, and do not bias scatterer location when mitigating nearby interference sources. The disclosed technology will overcome the limitations of both prior art Fraunhofer interference mitigation as well as Fresnel wave field imaging solutions.

There is a need for a means to search an extended field of view volume (i.e., a field of view larger than the spatial mainlobe width of a Fraunhofer plane wave) while simultaneously mitigating interference with transmission of a single transmitted pulse from a stationary sensor array. There is a need for Fresnel-based imaging pipelines that mitigate interference without biasing near-field or far-field scatterer localization. An approach to extended volume searching with interference mitigation can be achieved if interference signals arriving at the sensor array from a given Angle-of-Arrival are mitigated while processing the data of the sensor array with the echoes received from a single transmitted pulse.

There is a need for a “real” sensor array imaging method that mitigates interference for a single pulse, and is combined with “synthetic” array imaging processes. “Synthetic arrays” may be employed for imaging purposes. “Synthetic aperture radars” (SARs) commonly employ synthetic arrays for radar imaging purposes. Synthetic arrays may be formed as a single sensor element (antenna) traverses a predetermined (flight) path during the transmission and reception of many pulses. The single sensor element requires transmission/reception of multiple pulses, while moving, to create the “synthetic” array. There is a need to increase the effectiveness of synthetic array imaging methods in contested environments by inclusion of interference mitigation techniques on individual pulses across all transmit/receive actions.

There is a need for a means to mitigate interference sources by sensor array received data processing methods to form sensor array based imagery from a real, stationary, sensor array. Digital arrays are becoming more common forms of real arrays. A digital array removes analog hardware used for on-array analog processing to form and steer Fraunhofer plane wave beams. These digital arrays place analog-to-digital converters closer to each array sensor element, where discrete (i.e., digital) data is passed to a computer readable medium for processing by computer software. Digital arrays acquire sensor element data in digital format from each sensor element without Fraunhofer beamforming in analog circuitry.

There is a need for a new means to form imagery using interference mitigation techniques for single pulse transmit/receive actions from a stationary digital sensor array. There is also a need to form interference mitigated imagery with digital sensor array data gathered from the near-field or far-field of the sensor array. An additional need exists to combine stationary digital sensor array techniques that employ single-pulse interference mitigation with approaches based on multiple pulse moving sensor arrays and synthetic array operations. Data acquired from a single pulse for image generation, referred to as a “single-pulse dwell”, may be expanded into a “multiple-pulse dwell” where the digital sensor array undergoes motion in a manner similar to SAR applications. There is a need to employ single pulse imaging techniques to enhance the effectiveness of SAR-like imaging approaches that conventionally depend on sensor motion.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for generating interference-mitigated images of a scene within a sensed field of view is provided. The system comprises a sensor array comprising a plurality of sensor elements configured to transmit a waveform and receive corresponding echo and interference signals. The system comprises an adaptation device configured to receive data acquired by the sensor array, estimate or determine characteristics of interference within the received data, and mitigate the interference to generate interference-mitigated data. The system comprises a processor configured to reconstruct one-dimensional, two-dimensional, or three-dimensional images of the sensed field of view by performing Fresnel-based imaging operations on the interference-mitigated data. The data acquired by the sensor array is from transmission of a single pulse or a plurality of pulses, or corresponds to motion of the sensor array.

According to other aspects of the present disclosure, the system may include one or more of the following features. The sensor array may comprise a plurality of digital sensor elements having uniform or non-uniform spatial spacing, each configured to record digital samples synchronized in time and frequency. The adaptation device may be configured to partition a frequency bandwidth of the digital data into a plurality of subbands, mitigate interference within each subband, and recombine the plurality of subbands to form the interference-mitigated data. The adaptation device may be configured to apply analysis filters to form the plurality of subbands, perform interference mitigation within each subband, and apply synthesis filters to reconstruct a full-bandwidth signal. The adaptation device may comprise an adaptation antenna element configured to compute a finite-sample covariance matrix of interference and noise across a spatial dimension of the data acquired by the sensor array, and to mitigate interference using at least one of a sample-matrix inversion and an orthogonal-complement projection derived from eigenvectors of the covariance matrix. The adaptation device may comprise a subspace projection device configured to construct an orthogonal-complement projection from fast-time training samples, optionally constrained by a spatial-gradient term that enlarges a null space to suppress interference within the field of view. The adaptation device may comprise a deterministic filter device configured to apply predefined filters in one or more domains selected from the group consisting of time, frequency, spatial, and wavenumber domains, to attenuate predetermined interference bands or spatial sectors. The adaptation device may be configured to apply zero-padding to spatial samples of the interference-mitigated data, perform Discrete Fourier Transforms to relevant dimensions of the zero-padded, interference mitigated data, and to store the result in a frequency-wavenumber domain for processing by the processor. The processor may be configured to determine spatial reference points for the sensor array and the field of view, generate reference Fresnel field replicas representing modeled propagation between the sensor array and the field of view, compute inverse Huygens-Fresnel transfers by complex conjugation of Fourier-transformed replicas, perform elementwise complex multiplication of the interference-mitigated data in the frequency and wavenumber domain with the inverse Huygens-Fresnel transfers to generate scene-centered frequency-wavenumber data, perform wavenumber remapping to produce an angular spectrum, and execute wavenumber migration and inverse Fourier transformation to form an interference-mitigated image of the field of view. The processor may be further configured to integrate interference mitigated image data generated from multiple pulses corresponding to multiple spatial positions of the sensor array to enhance scatterer point-spread-function resolution, Signal-to-Noise-Ratio, and Signal-to-Interference-plus-Noise-Ratio.

According to another aspect of the present disclosure, a method for generating an interference-mitigated image of a scene within a sensed field of view is provided. The method comprises transmitting, by a plurality of sensor elements of a sensor array, a waveform toward the field of view. The method comprises receiving, by the plurality of sensor elements, corresponding echo and interference signals. The method comprises storing data representative of the received signals. The method comprises mitigating interference within the data using an adaptation device configured to perform statistical estimation, subspace projection, or deterministic filtering of the data. The method comprises reconstructing an image of the field of view by performing one or more Fresnel-based imaging operations selected from the group consisting of replica generation, inverse Huygens-Fresnel transformation, and wavenumber migration.

According to other aspects of the present disclosure, the method may include one or more of the following features. The method may further comprise integrating interference mitigated image data generated from multiple spatial positions of the sensor array to enhance scatterer point-spread-function resolution. Mitigating interference may comprise computing a finite-sample covariance matrix of interference and noise across a spatial dimension of the data representative of the received signals and applying sample-matrix inversion or orthogonal-complement projection derived from eigenvectors of the covariance matrix. Mitigating interference may comprise applying orthogonal-complement projection derived from eigenvectors of the covariance matrix, and the orthogonal-complement projection may be constrained by a spatial-gradient term that enlarges a null space to suppress interference within the field of view. Mitigating interference may comprise partitioning frequency bandwidth of the data into a plurality of subbands, applying interference mitigation within each of the plurality of subbands, and recombining the plurality of subbands. Partitioning may comprise applying analysis filters to form the plurality of subbands and applying synthesis filters to reconstruct a full-bandwidth signal after interference mitigation.

According to another aspect of the present disclosure, a non-transitory computer-readable medium storing instructions that, when executed by one or more processors, cause the one or more processors to perform operations is provided. The operations comprise receiving digital data acquired by a sensor array. The operations comprise mitigating interference in the data using statistical, subspace, or deterministic filtering operations. The operations comprise generating reference Fresnel field data and corresponding inverse Huygens-Fresnel transfers. The operations comprise performing wavenumber remapping and migration. The operations comprise reconstructing an interference-mitigated image of a sensed field of view based on the mitigated data.

According to other aspects of the present disclosure, the non-transitory computer-readable medium may include one or more of the following features. Mitigating interference may comprise computing a finite-sample covariance matrix of interference and noise across a spatial dimension of the received data and applying sample-matrix inversion or orthogonal-complement projection derived from eigenvectors of the covariance matrix. Mitigating interference may comprise applying orthogonal-complement projection derived from eigenvectors of the covariance matrix, and the orthogonal-complement projection may be constrained by a spatial-gradient term that enlarges a null space to suppress interference within the field of view. The operations may further comprise integrating interference mitigated image data generated from multiple spatial positions of the sensor array to enhance scatterer point-spread-function resolution, Signal-to-Noise-Ratio, and Signal-to-Interference-plus-Noise-Ratio.

These and other aspects of the present disclosure are described in the Detailed Description below and the accompanying drawings. Other aspects and features of embodiments will become apparent to those of ordinary skill in the art upon reviewing the following description of specific, exemplary embodiments in concert with the drawings. While features of the present disclosure may be discussed relative to certain embodiments and figures, all embodiments of the present disclosure can include one or more of the features discussed herein. Further, while one or more embodiments may be discussed as having certain advantageous features, one or more of such features may also be used with the various embodiments discussed herein. In similar fashion, while exemplary embodiments may be discussed below as device, system, or method embodiments, it is to be understood that such exemplary embodiments can be implemented in various devices, systems, and methods of the present disclosure.

### BRIEF DESCRIPTION OF FIGURES

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1 illustrates a block diagram of a system according to one aspect of the disclosed technology.

FIG. 2 illustrates a block diagram of the Adaptation Device and its variants used to mitigate interference, according to one aspect of the disclosed technology.

FIG. 3 illustrates a block diagram illustrating operation of the system of FIG. 1, according to one aspect of the disclosed technology.

FIG. 4 illustrates a uniform linear sensor array with uniformly spaced elements, according to one aspect of the disclosed technology.

FIG. 5 illustrates a linear sensor array with non-uniformly spaced elements, according to one aspect of the disclosed technology.

FIG. 6 illustrates a uniform planar sensor array, with uniformly spaced sensor elements, according to one aspect of the disclosed technology.

FIG. 7 illustrates a conformal sensor array according to one aspect of the disclosed technology.

FIG. 8 illustrates dimensions of data recorded by sensor elements, according to one aspect of the disclosed technology. Multiple samples for a given pulse are termed “fast-time” samples while each sensor element is deemed a “spatial” sample. Multiple pulses correspond to the “slow-time” dimension.

FIG. 9 illustrates definition of near-field and far-field of a sensor array according to one aspect of the disclosed technology.

FIG. 10 illustrates geometry of the scene and its different dimensions ac-cording to one aspect of the disclosed technology.

FIG. 11 illustrates a two-dimensional field of view interference mitigated image using sample matrix inversion employed by the Adaptation Antenna Element Device variant of the Adaptation Device in the near-field of the Sensor Array, ac-cording to one aspect of the disclosed technology.

FIG. 12 illustrates a lack of interference mitigation using prior art Fresnel-based imaging pipelines in the near-field of the Sensor Array, according to one aspect of the disclosed technology.

FIG. 13 illustrates a sensing geometry with multiple sensor arrays as well as a corresponding field of view containing scatterers and interference sources, according to one aspect of the disclosed technology.

FIG. 14 illustrates a two-dimensional field of view interference mitigated image generated by integrating interference mitigated images from single-pulse collections corresponding to sensor array placement illustrated in FIG. 13 in the far-field of the Sensor Array, according to one aspect of the disclosed technology.

FIG. 15 illustrates a two-dimensional field of view interference mitigated image generated by integrating interference mitigated images from single-pulse collections corresponding to sensor array placement illustrated in FIG. 13 in the far-field of the Sensor Array, according to one aspect of the disclosed technology.

FIG. 16 illustrates a volumetric interference mitigated data product generated by a uniform planar array for a single pulse, according to one aspect of the disclosed technology.

FIG. 17 illustrates positions of scatterers, interference sources, and reference centroid of the sensor array corresponding to FIG. 16, according to one aspect of the disclosed technology.

FIG. 18 illustrates interference mitigated one-dimensional data product corresponding to the cross-range point spread function of a scatterer with scatterer and interference source location (in cross-range) clearly defined, according to one aspect of the disclosed technology.

FIG. 19 illustrates failure of prior art to mitigate interference signals in a one-dimensional data product corresponding to the cross-range dimension, with scatterer location and interference source location clearly defined.

FIG. 20 illustrates a two-dimensional field of view interference mitigated image using sample matrix inversion employed by the Adaptation Antenna Element Device variant of the Adaptation Device in the far-field of the Sensor Array, according to one aspect of the disclosed technology.

FIG. 21 illustrates failure of prior art to mitigate interference signals in a two-dimensional data product, with interference source and scatterer locations clearly defined.

FIG. 22 illustrates a two-dimensional data product received by the digital sensor elements of the sensor array and stored in the sensor data buffer, according to one aspect of the disclosed technology.

FIG. 23 illustrates zero-padding to each side of the spatial samples of the sensor array for interference mitigated data with respect to the number of cross-range samples of the field of view, according to one aspect of the disclosed technology.

FIG. 24 illustrates a multirate architecture used to mitigate interference signals in the sensor data buffer using frequency subbands, according to one aspect of the disclosed technology.

FIG. 25 illustrates a two-dimensional field of view interference mitigated image using eigenvector orthogonal complement projections employed by the Adaptation Antenna Element Device variant of the Adaptation Device in the near-field of the Sensor Array, according to one aspect of the disclosed technology.

FIG. 26 illustrates a two-dimensional field of view interference mitigated image using eigenvector orthogonal complement projections employed by the Adaptation Antenna Element Device variant of the Adaptation Device in the far-field of the Sensor Array, according to one aspect of the disclosed technology.

FIG. 27 illustrates a two-dimensional field of view interference mitigated image using an orthogonal complement projection employed by the Subspace Projection Device variant of the Adaptation Device in the near-field of the Sensor Array, according to one aspect of the disclosed technology.

FIG. 28 illustrates a two-dimensional field of view interference mitigated image using an orthogonal complement projection employed by the Subspace Projection Device variant of the Adaptation Device in the far-field of the Sensor Array, according to one aspect of the disclosed technology.

FIG. 29 illustrates a two-dimensional field of view interference mitigated image using an orthogonal complement projection, with a gradient constraint, employed by the Subspace Projection Device variant of the Adaptation Device in the near-field of the Sensor Array, according to one aspect of the disclosed technology.

FIG. 30 illustrates a two-dimensional field of view interference mitigated image using an orthogonal complement projection, with a gradient constraint, employed by the Subspace Projection Device variant of the Adaptation Device in the far-field of the Sensor Array, according to one aspect of the disclosed technology.

FIG. 31 illustrates a two-dimensional field of view interference mitigated image using a deterministic filter employed by the Deterministic Filter Device in the near-field of the sensor array, according to one aspect of the disclosed technology.

FIG. 32 illustrates contents of the replica data buffer corresponding to the near-field of the sensor array, according to one aspect of the disclosed technology.

FIG. 33 illustrates contents of the replica data buffer corresponding to the far-field of the sensor array, according to one aspect of the disclosed technology.

FIG. 34 illustrates multiple fields of view according to one aspect of the disclosed technology.

FIG. 35 illustrates contents of the Inverse Huygens-Fresnel Transfer Data Buffer corresponding to the near-field of the sensor array, according to one aspect of the disclosed technology.

FIG. 36 illustrates contents of the Inverse Huygens-Fresnel Transfer Data Buffer corresponding to the far-field of the sensor array, according to one aspect of the disclosed technology.

FIG. 37 illustrates contents of the Scene Centered Frequency Wavenumber Data Buffer corresponding to the near-field of the sensor array, according to one aspect of the disclosed technology.

FIG. 38 illustrates contents of the Scene Centered Frequency Wavenumber Data Buffer corresponding to the far-field of the sensor array, according to one aspect of the disclosed technology.

FIG. 39 illustrates contents of the interference mitigated wavenumber migrated data corresponding to the near-field of the sensor array, according to one aspect of the disclosed technology.

FIG. 40 illustrates contents of the interference mitigated wavenumber migrated data corresponding to the far-field of the sensor array, according to one aspect of the disclosed technology.

FIG. 41 illustrates improved resolution of scatterer cross-range point spread function in image data product due to integration of multiple pulses of interference mitigated images, according to one aspect of the disclosed technology.

FIG. 42 illustrates failure of prior art Fraunhofer beamforming with interference mitigation in the near-field of the sensor array.

FIG. 43 illustrates success of proposed technology for mitigating interference and resolving scatterer point spread function in the near-field of the sensor array, according to one aspect of the disclosed technology.

### DETAILED DESCRIPTION

Although preferred exemplary embodiments of the disclosure are explained in detail, it is to be understood that other exemplary embodiments are contemplated. Accordingly, it is not intended that the disclosure is limited in its scope to the details of construction and arrangement of components set forth in the following description or illustrated in the drawings. The disclosure is capable of other exemplary embodiments and of being practiced or carried out in various ways. Also, in describing the preferred exemplary embodiments, specific terminology will be resorted to for the sake of clarity.

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

As used in the specification and the appended claims, the singular forms “a,” “an” and “the” include plural referents unless the context clearly dictates otherwise.

Also, in describing the preferred exemplary embodiments, terminology will be resorted to for the sake of clarity. It is intended that each term contemplates its broadest meaning as understood by those skilled in the art and includes all technical equivalents which operate in a similar manner to accomplish a similar purpose.

By “comprising” or “containing” or “including” is meant that at least the named compound, member, particle, or method step is present in the composition or article or method, but does not exclude the presence of other compounds, materials, particles, method steps, even if the other such compounds, material, particles, method steps have the same function as what is named.

Mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The materials described as making up the various members of the invention are intended to be illustrative and not restrictive. Many suitable materials that would perform the same or a similar function as the materials described herein are intended to be embraced within the scope of the invention. Such other materials not described herein can include, but are not limited to, for example, materials that are developed after the time of the development of the invention.

Reference will now be made in detail to exemplary embodiments of the disclosed technology, examples of which are illustrated in the accompanying drawings and disclosed herein. Wherever convenient, the same reference numbers will be used throughout the drawings to refer to the same or like parts.

### System Overview

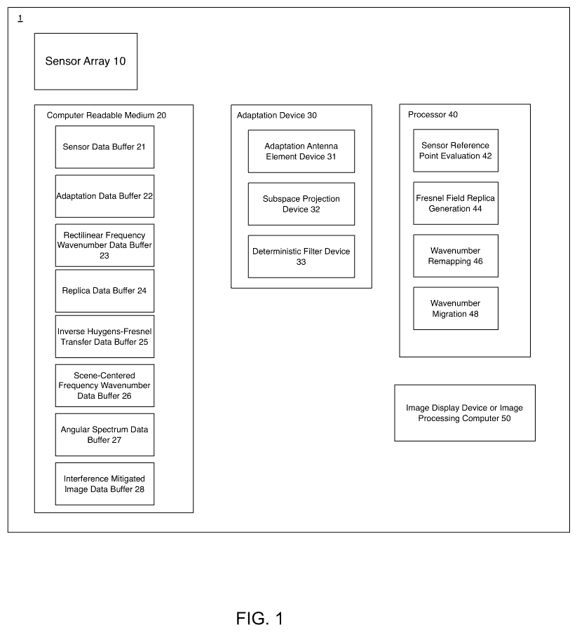

The disclosed technology pertains, in various embodiments, to systems employing sensor arrays of discrete sensing elements that acquire data used for interference mitigation and image formation within the field of view of the Sensor Array 10. As illustrated in FIG. 1-3, an example interference mitigation and signal processing system includes a Sensor Array 10 configured to perform imaging operations through transmission of a single-pulse waveform, where all transmitter-receiver elements of the array emit the waveform concurrently. The single-pulse waveform may take numerous forms, including a continuous wave signal, a time-limited pulse, a frequency-modulated chirp, a composite sequence of sub-pulses, a phase-coded signal, or other suitable waveform possibilities.

The Sensor Array 10 may include a plurality of sensor elements. A sensor element may be an antenna element. An antenna element may receive echo signals in response to transmission of the pulse waveforms as well as interference signals in the environment. Each sensor element may record digital data indicative of the echo and interference signals to be used by the System 1. Sensor elements that record digital data can be referred to as Digital Sensor Elements 11. A Sensor Array 10 composed of Digital Sensor Elements 11 may have time syncing across Digital Sensor Elements 11 such that they record samples at the same instance of time (or nearly the same instance of time), use the same sampling rate, and are tuned to the same band of frequencies. The Digital Sensor Elements 11 can be associated with spatial location positions.

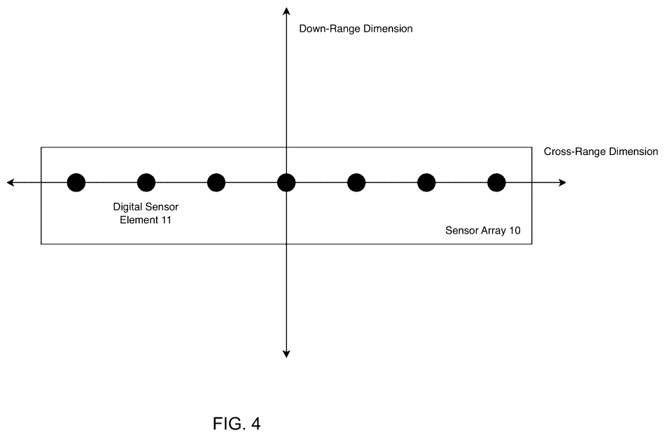

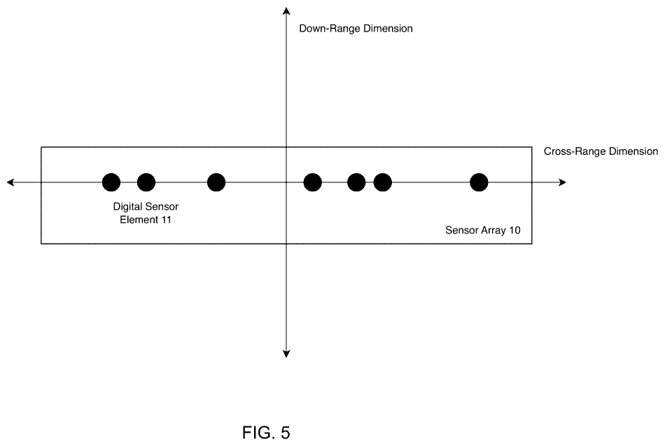

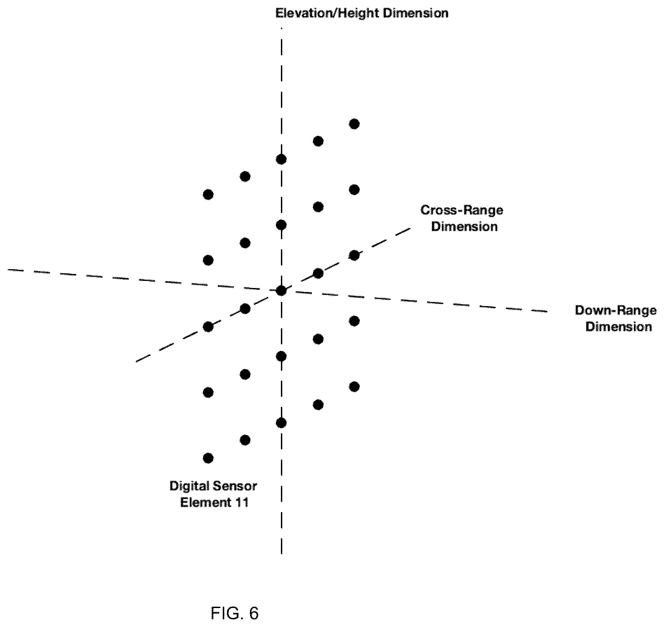

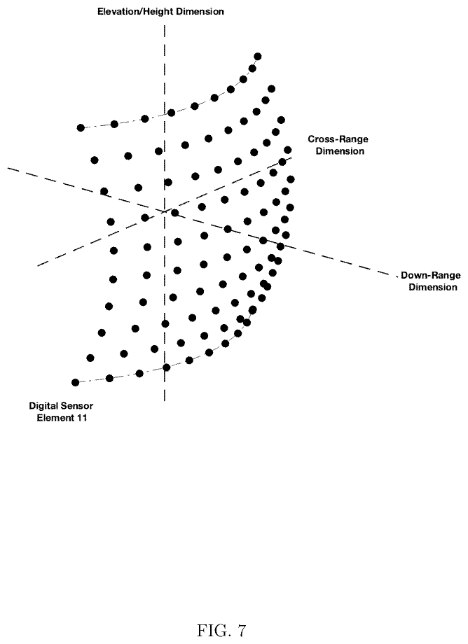

The Sensor Array 10 can have any number of Digital Sensor Elements 11, in accordance with various embodiments of the present disclosure. The Sensor Array 10 may have predefined spacing of Digital Sensor Elements 11. The predefined spacing of Digital Sensor Elements 11 of the Sensor Array 10 may be uniform or nonuniform, as depicted in FIG. 4-5, respectively, for a one-dimensional array. The Sensor Array 10 may be one-dimensional, two-dimensional, or multidimensional. FIG. 4 depicts a one-dimensional array with spatial location variation of Digital Sensor Elements 11 in one-dimension only. FIG. 6 depicts a two-dimensional array with spatial location variation of Digital Sensor Elements 11 in two dimensions. As shown in FIG. 7, the Sensor Array 10 may be multidimensional with spatial location variation of Digital Sensor Elements 11 in multiple dimensions, such as those of a conformal array.

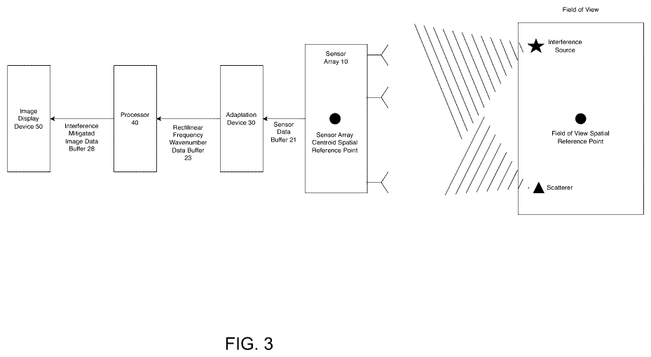

The exemplary System 1 depicted in FIG. 3 demonstrates a system for creating interference mitigated images of a Sensor Array's 10 field of view. The Sensor Array 10 may have all sensor elements simultaneously transmit the same single pulse signal. A “single pulse” may be a waveform such as a frequency modulated continuous waveform, a pulsed waveform, a phase modulated waveform, or one of many other possibilities.

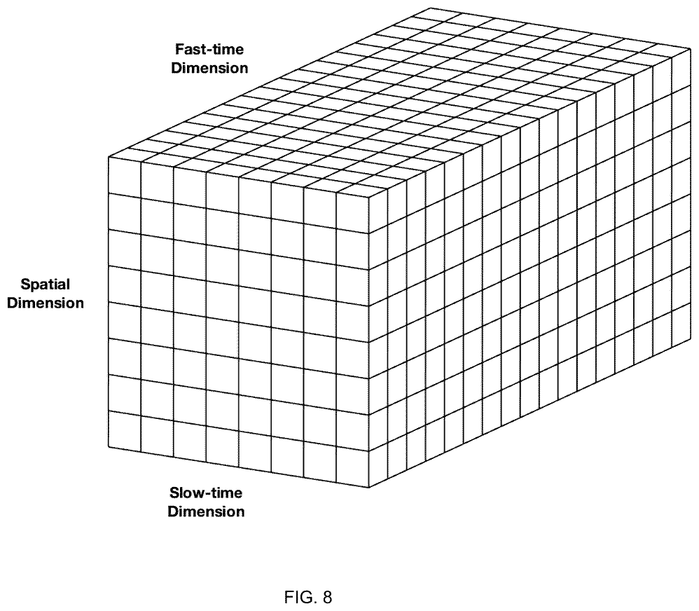

In the context of the present disclosure, there are multiple dimensions to the types of data received by the Digital Sensor Elements 11 of the Sensor Array 10. The “fast-time” data refers to temporal samples recorded by the Digital Sensor Elements 11 over the course of a Pulse Repetition Interval (PRI). The “spatial” data refers to samples at the same time instant recorded by all samples of the Digital Sensor Elements 11. The “slow-time” data refers to samples across PRIs. The slow-time data may be associated with movement of the Sensor Array 10 across all PRIs. All data collected across spatial, fast-time, and slow-time dimensions may collectively be referred to as a “datacube”. The data associated with the datacube may be referred to as a Coherent Processing Interval (CPI). An example of a datacube for a given CPI is illustrated in FIG. 8. The term PRI is traditionally used for pulsed waveforms and is an example which should not limit the range of possible waveforms which may be employed by the System 1. As an example, frequency modulated continuous waveforms may use “chirps” instead of a PRI since the waveform is not pulsed.

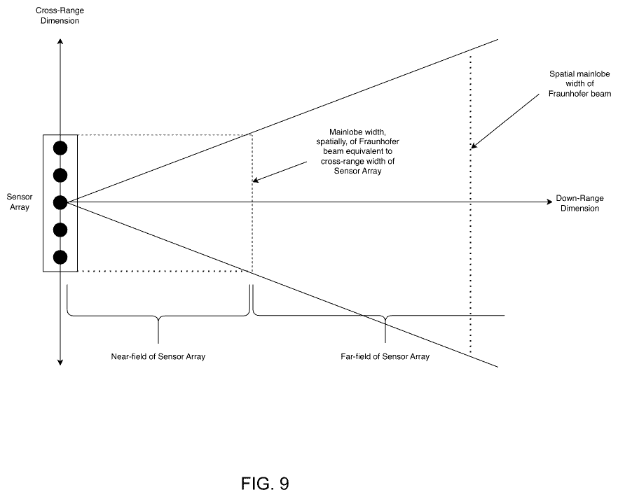

In the context of the present disclosure, there will be reference to a “near-field” and a “far-field”. The near-field refers to the distance from the Sensor Array 10 where the spatial beam width of a traditionally formed Fraunhofer plane wave beam is smaller than the cross-range extent of the Sensor Array 10. The far-field refers to the distance from the Sensor Array 10 where the spatial beam width of a traditionally formed Fraunhofer plane wave beam is as large, or larger, than the cross-range extent of the Sensor Array 10. FIG. 9 demonstrates the boundary between the near-field and far-field of the Sensor Array 10.

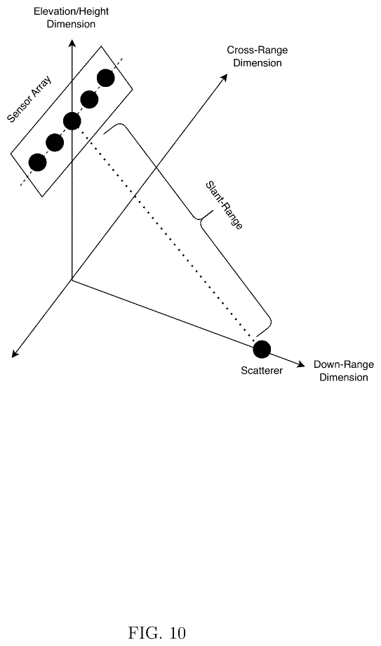

There may be multiple spatial dimensions associated with the Sensor Array 10, field of view, and image generated by the System 1. FIG. 10 depicts these dimensions. The cross-range dimension may refer to the axis perpendicular to a bearing line between the centroid of the Sensor Array 10 and the field of view. The elevation dimension may refer to any height difference between the centroid of the Sensor Array 10 and the field of view. The slant-range dimension may refer to the bearing line between the centroid of the Sensor Array 10 and the field of view, which includes elevation. The down-range dimension may refer to the component of the slant-range dimension that does not include elevation. The spatial distance of each dimension in the image generated by the System 1 may be arbitrarily set or predefined.

The System 1 may form images representative of the scatterers of objects within the sensor array's 10 field of view. A scatterer is a part of an object that reflects the transmitted waveform to the Sensor Array 10. The image formed by the System 1 may be comprised of samples, pixels, and/or voxels describing the “strength” of the received waveform, the phase of the received waveform, and the potential position of the scatterer from which the waveform was reflected. The strength refers to the amplitude of the sample, pixel, and/or voxel. The phase refers to the complex phase values of the sample, pixel, and/or voxel. The position refers to the position value within the field of view of the image with respect to other samples, pixels, and/or voxels. Interference signals may be able to mimic any of the three aforementioned properties such that the resulting image is not representative of the scatterers in the field of view.

The Sensor Array 10, as used herein, can include, but is not limited to, radar antenna arrays, ultrasound antenna arrays, sonar antenna arrays, and acoustic antenna arrays. The Sensor Array 10 may perform radio frequency electromagnetic sensing, ultrasonic acoustic sensing, and/or lower frequency acoustic sensing. Acoustic sensing may occur in air or water.

As shown in FIG. 1, in some embodiments, the System 1 may include a Computer Readable Medium 20, Adaptation Device 30, Processor 40, and an Image Display Device or Image Processing Computer 50.

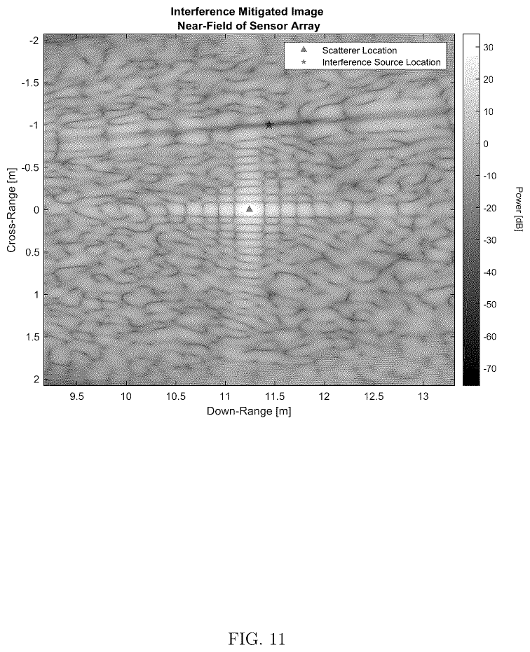

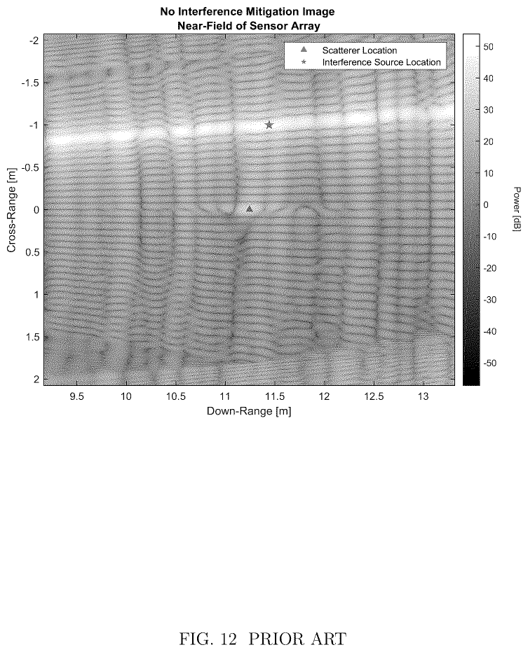

Unlike traditional Fresnel-based imaging pipelines, embodiments of the disclosed technology can generate interference mitigated images of the field of view using transmission and reception of echoes from a single pulse in both the near-field and far-field of the Sensor Array 10. Interference refers to unwanted signals received by the Digital Sensor Elements 11 of the Sensor Array 10, which decrease Signal-to-Interference-plus-Noise-Ratio (SINR) and result in distortion and/or corruption of images generated by Fresnel-based imaging pipelines. Examples of interference sources include, but are not limited to, civilian radiofrequency infrastructure (cell sites, Wi-Fi, broadcast radio, etc.), jamming, clutter, and co-channel transmissions. An example of an interference mitigated image is illustrated in FIG. 11, where a single pulse worth of echoes is received by the Digital Sensor Elements 11 of the Sensor Array 10 and the Adaptation Device 30 mitigates all interference signatures arriving from a given bearing line relative to the Sensor Array 10. The Sensor Array 10 used to generate this image is a one-dimensional Sensor Array 10 with uniform spatial spacing of the Digital Sensor Elements 11. The image of the interference mitigated field of view may be displayed by the Image Display Device or Image Processing Computer 50. The same data without mitigating interference is illustrated in FIG. 12. Spatial positions of the scatterers and interference sources in the field of view are illustrated in FIG. 11-12.

Unlike conventional Fraunhofer-based beamforming and adaptive cancellation, which assume a plane-wave model and form angular nulls through linear spatial weighting, embodiments of the present disclosure can employ Fresnel-based imaging, which operates under a spherical-wave propagation model in which the curvature of the phase front varies with range. Embodiments of the present disclosure can perform interference mitigation directly within the reconstruction process, where phase corrections depend jointly on range and cross-range coordinates. As a result, the interference-suppression operations cannot be implemented by a simple linear combination of prior Fraunhofer adaptive beamformers that do not account for the cross-range wavenumber bandwidth supplied by multiple spatial samples recorded by the Digital Sensor Elements 11 of the Sensor Array 10. In particular, applying conventional plane-wave nulling techniques prior to Fresnel reconstruction, especially in broadband (i.e., wideband) signals distorts the curvature of valid signal returns, whereas the disclosed adaptation device achieves interference mitigated data that remains covariant with the Fresnel propagation model, thereby preserving scatterer localization while mitigating interference.

Unlike prior Fraunhofer beamforming techniques that mitigate interference signals in the far-field and prior covariant Fresnel-based single pulse imaging pipelines that assume interference-free sensing environments, embodiments of the present disclosure can integrate interference suppression within the Fresnel-based image-formation architecture. This permits near-field and far-field imaging from a single-pulse dwell without biasing scatterer localization. The disclosed technology may apply interference mitigation within the spatial mainlobe of conventional Fraunhofer beamforming without biasing reconstructed scatterer point spread function localization, unlike prior Fraunhofer interference mitigation techniques.

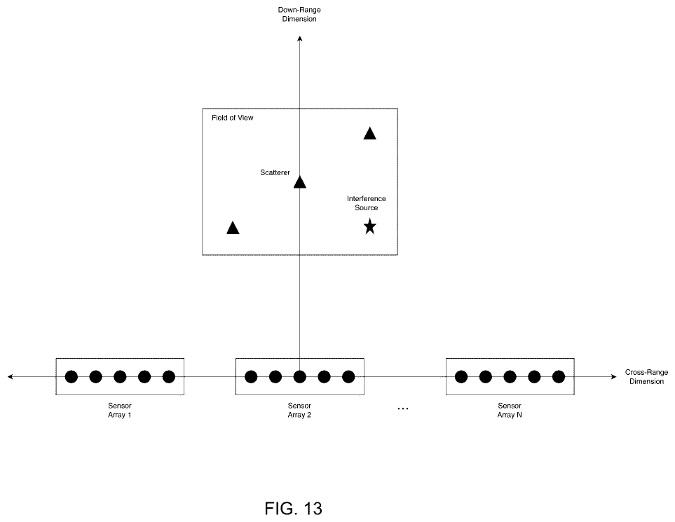

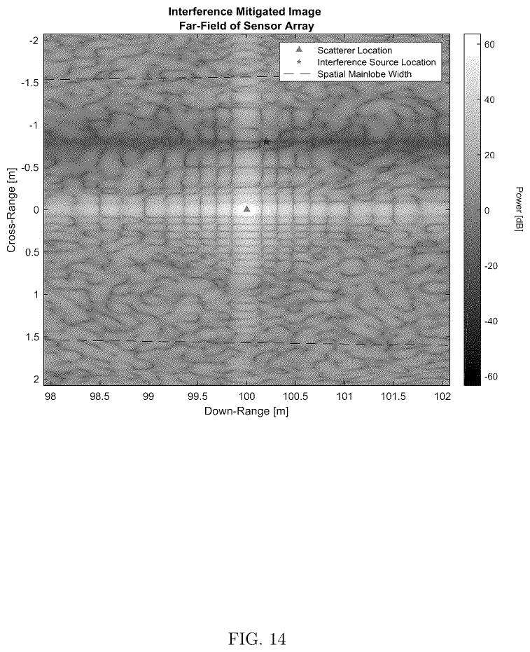

The Processor 40 may integrate complex samples, pixels, and/or voxels of image data associated with Sensor Arrays 10 from various unique spatial locations. These unique Sensor Array 10 locations may occur due to motion of the Sensor Array 10 between pulses, or as a result of multiple mobile or stationary Sensor Arrays 10 operating in the environment. FIG. 13 illustrates an aperture associated with a multiple stationary Sensor Array 10 environment. FIG. 14 depicts a two-dimensional interference mitigated image generated by integrating complex image pixel data generated from each of the stationary Sensor Array 10 locations, as depicted in FIG. 13. Interference is mitigated individually in each image prior to integration.

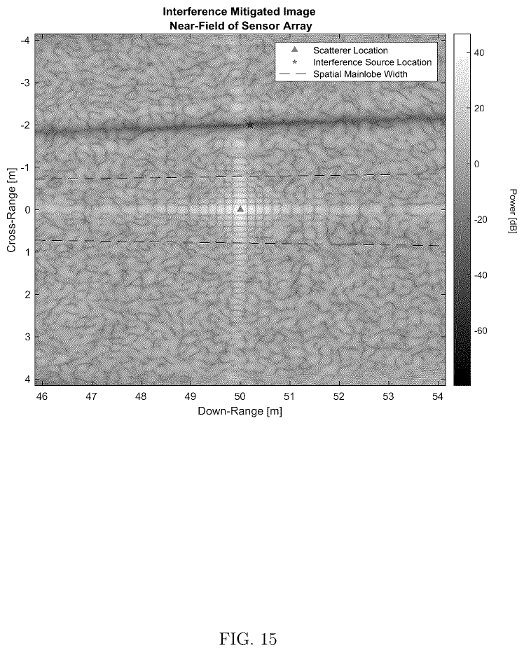

As used herein, Adaptation Device 30 and its variants, e.g., Adaptation Antenna Element Device 31, Subspace Projection Device 32, and Deterministic Filter Device 33, refers to any combination or hardware and/or software for performing the various functions disclosed herein. For example, in some embodiments, the Adaptation Device can comprise one or more software modules that can be executed by the Processor 40. In some embodiments, the Adaptation Device can comprise one or more software modules and an independent processor for executing those software modules. The Adaptation Device 30 can be configured to mitigate interference arising from either the sidelobes or the mainlobe of a traditional Fraunhofer plane wave beam. Integration of complex samples, pixels, and/or voxels of interference mitigated images associated with unique spatial locations of the Sensor Array 10 may result in improved resolution of the Point Spread Function (PSF) associated with a given scatterer. A PSF describes the resolution of the imagery with respect to the focusing of a single scatterer. Unlike prior art Fraunhofer interference mitigation beamforming techniques that may bias Angle-of-Arrival estimates of scatterer echoes in the presence of intra-mainlobe interference mitigation, embodiments of the present disclosure can resolve the location of scatterers in the field of view of the Sensor Array 10 when mitigating interference that would traditionally fall within the mainlobe of prior art Fraunhofer beamforming techniques. An example of an interference mitigated image which is generated from integration of pixels associated with multiple Sensor Array 10 positions is displayed in FIG. 14. The interference source would fall within the mainlobe of prior art Fraunhofer beamforming techniques for each Sensor Array 10 position. FIG. 15 depicts an interference mitigated image which is generated from integration of pixels associated with multiple Sensor Array 10 positions. The interference source would fall within the sidelobe of prior art Fraunhofer beamforming techniques for each Sensor Array 10 position.

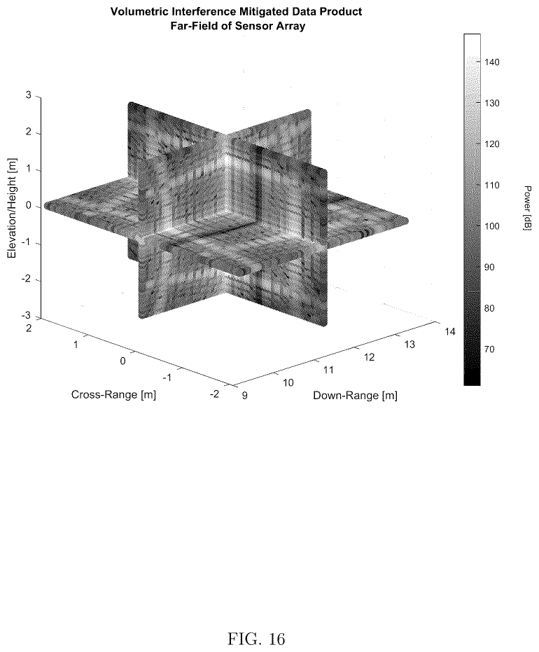

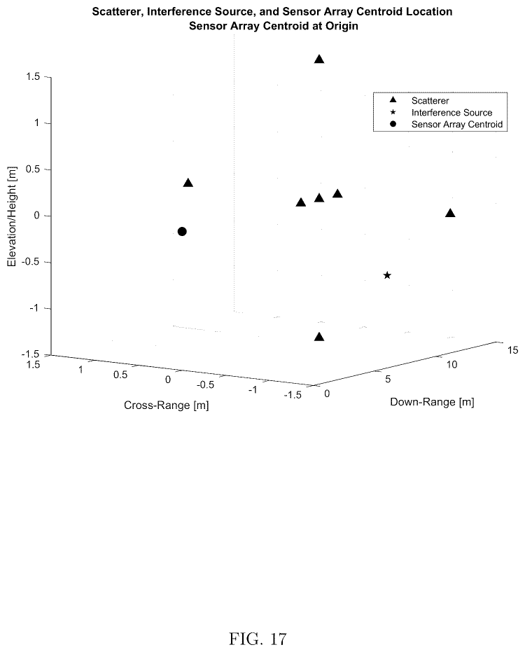

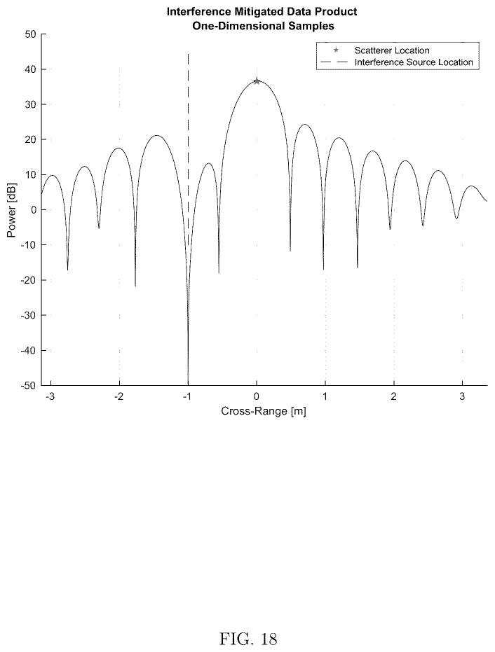

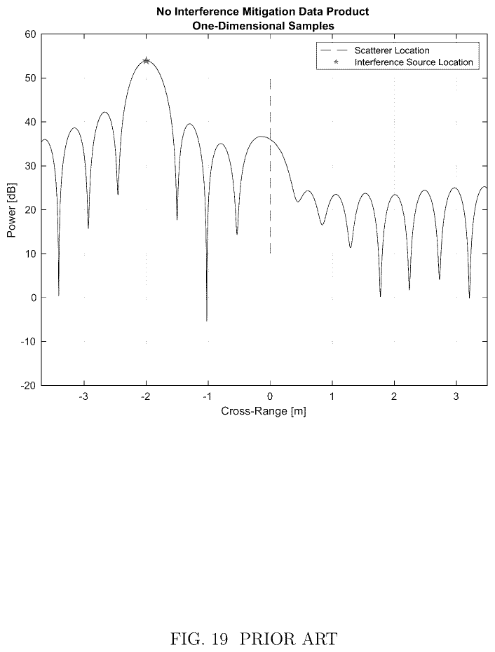

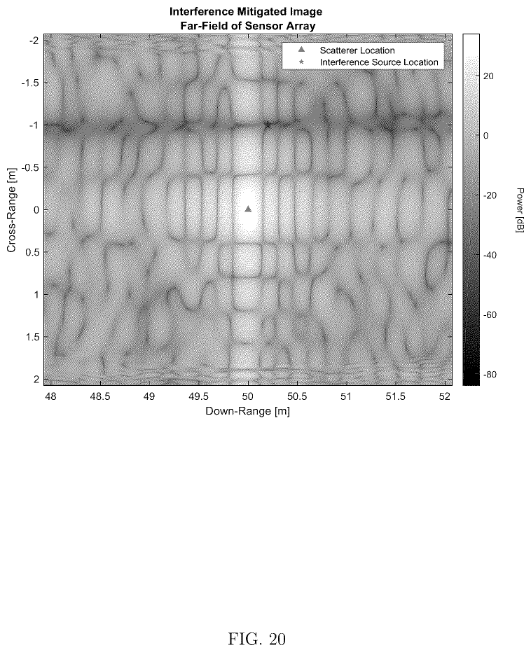

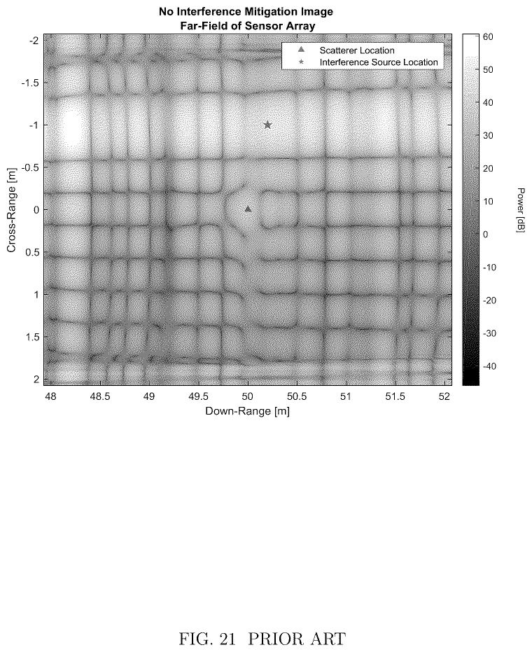

The interference mitigated image may also be volumetric. FIG. 16 illustrates an interference mitigated image in the field of view using three-dimensional voxels produced by the present invention. FIG. 17 illustrates the location of the scatterers and interference source relative to the spatial location of the centroid of the Sensor Array 10. The interference mitigated image may also comprise one-dimensional samples. FIG. 18 illustrates an interference mitigated one-dimensional image of the field of view. FIG. 19 illustrates prior art failure to mitigate interference signals in the field of view. The interference mitigated image may also comprise two-dimensional pixels. FIG. 20 illustrates an interference mitigated two-dimensional image of the field of view. FIG. 21 illustrates the same field of view as FIG. 20, but without interference mitigation.

In one embodiment, the interference mitigated image of the field of view of the Sensor Array 10 may use predefined sample, pixel, and/or voxel spacing in any dimension. The predefined spacing of the samples, pixels, and/or voxels may be proportional to, including possibly equal to, a predefined spacing between the Digital Sensor Elements 11 of the Sensor Array 10. This means that the reference spatial locations in the field of view corresponding to adjacent samples, pixels, and/or voxels is proportional to, including possibly equal to, the physical spatial distance between two Digital Sensor Elements 11 of the Sensor Array 10. As an example, for a predefined spacing between adjacent Digital Sensor Elements 11 of the Sensor Array 10 that is equal to half the wavelength of a transmitted waveform, the sample spacing of pixels in the output image may also be set to half the wavelength of the same transmitted waveform. Each sample, pixel, and/or voxel may be associated with a location in the physical environment of the field of view. The total number of samples, pixels, and/or voxels in the image may span a cross-range extent that is less than, equal to, or greater than the cross-range extent of the Digital Sensor Elements 11 of the Sensor Array 10.

The Sensor Array 10 may be stationary or mobile. The Processor 40 may command movement of the Sensor Array 10 along a predetermined path. The Digital Sensor Elements 11 of the Sensor Array 10 may record data that includes, but is not limited to, echoes reflected by scatterers as well as interference corresponding to single pulses (e.g., a single PRI) for each position of the Sensor Array 10 along the predetermined path. The Adaptation Device 30 can be configured to mitigate interference in the data received by the Digital Sensor Elements 11 of the Sensor Array 10 for each pulse. The Processor 40 can be configured to generate images from the interference mitigated data for each pulse. The Processor 40 may integrate samples, pixels, and/or voxels of interference mitigated images generated from multiple pulses to improve the cross-range resolution of the resulting image within the field of view of the Sensor Array 10. The Processor 40 may generate images from interference mitigated data collected over a long predetermined path, or from a moving field of view as in Inverse Synthetic Aperture Radar systems, to improve cross-range resolution such that the resolution is proportional to the transmitted signal wavelength.

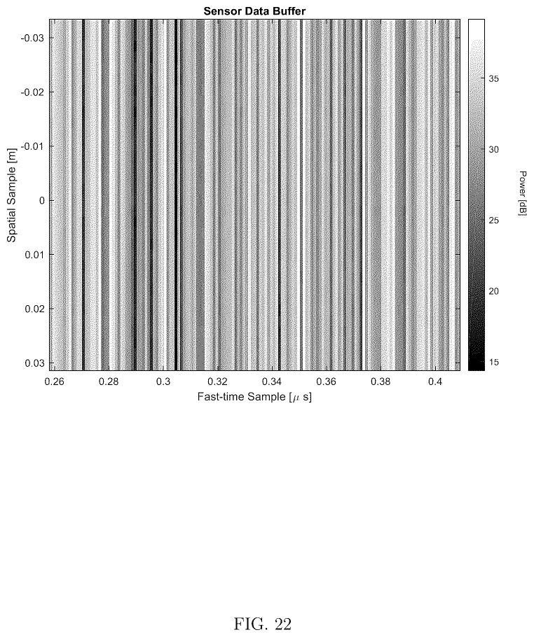

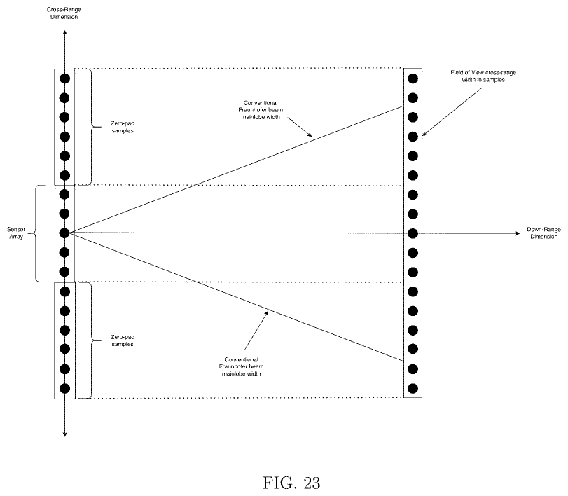

The System 1 may include the Sensor Data Buffer 21 for storing data received/recorded by the Digital Sensor Elements 11 of the Sensor Array 10. FIG. 22 illustrates data stored in the Sensor Data Buffer 21 corresponding to the far-field of the Sensor Array 10. The Adaptation Device 30 can be configured to mitigate interference in the data stored in the Sensor Data Buffer 21. The Adaptation Device 30 may mitigate interference in the near-field or far-field of the Sensor Array 10. The Adaptation Device 30 may zero-pad interference mitigated data on each side of the spatial samples of the interference mitigated data. The total size of the zero-pad may be equal to the number of pixels in the cross-range and/or elevation dimension of the field of view to be imaged by the Processor 40, minus the number of spatial samples in the interference mitigated data. FIG. 23 illustrates the zero-padding of the spatial samples with respect to the field of view. The minimum cross-range width of the field of view may be set to the cross-range width of the Sensor Array 10.

### Adaptation Device and Variants

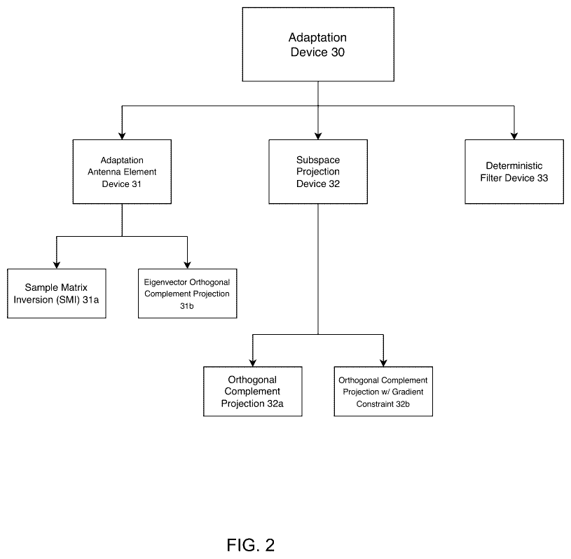

The Adaptation Device 30 may have variants. These include an Adaptation Antenna Element Device 31, a Subspace Projection Device 32, and a Deterministic Filter Device 33. Collectively, and generically, each of these may be referred to as an Adaptation-Variant Device. FIG. 2 illustrates a block diagram linking the Adaptation Device 30 to its variants and their techniques. The Adaptation Device 30, and all of its variants, can be configured to mitigate interference signals arriving from one, or a plurality of, interference sources.

The Adaptation Device 30 can receive data from the Sensor Data Buffer 21 and perform interference mitigation operations prior to Fresnel-based image reconstruction. All adaptation-variant devices can share a common processing framework that can include:
1. Partitioning the received data into one or more frequency subbands,
2. Applying interference-mitigation logic within each subband, and
3. Storing the full-band interference-mitigated data, after recombination and formatting, to the Rectilinear Frequency Wavenumber Data Buffer 23 for subsequent processing by the Processor 40.

In some embodiments, the Adaptation Device 30 mitigates interference within subsets of the frequency content of data stored in the Sensor Data Buffer 21. The subsets of frequency content are referred to as “subbands”. The Adaptation Device 30 can partition the frequency bandwidth of the data into multiple subbands. Each subband can correspond to a narrow portion of the overall bandwidth such that, in combination, the subbands collectively span the full frequency bandwidth of the data. In some embodiments, the Adaptation Device 30 employs one or more subbands during operation, and adjacent subbands may partially overlap in frequency.

The number of subbands, and the frequency bounds associated with each subband, may be predefined. In some embodiments, the Adaptation Device 30 filters the fast-time dimension of the data stored in the Sensor Data Buffer 21 using a set of predefined filters having passbands corresponding to the frequency bounds of the respective subbands. Filtering may be applied using prior art techniques such as time-domain convolution or frequency-domain multiplication. These predefined passband filters are referred to as “analysis filters”, and there can be a unique analysis filter for each subband. The analysis-filtered output corresponding to each subband is referred to as subband data. The subband data may be downsampled such that the sampling rate is equivalent to, or greater than, the frequency bounds of the corresponding subband. Downsampling may be performed by a variety of conventional techniques. The set of all downsampled subband data, covering the full frequency bandwidth of the original signal, can be stored in the Adaptation Data Buffer 22.

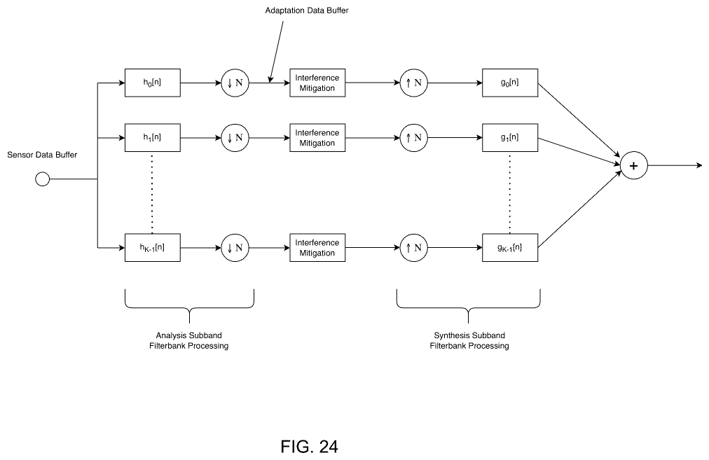

Following interference mitigation on the Adaptation Data Buffer 22, the Adaptation Device 30 may upsample the interference mitigated subband data such that the sampling rate of each subband is equivalent to the original sampling rate of the data stored in the Sensor Data Buffer 21. Upsampling the subbands may be performed by conventional fast-time interpolation or frequency domain zero-padding techniques. The Adaptation Device 30 can apply a secondary set of predefined filters, referred to as “synthesis filters” to the interference mitigated, upsampled, subband data. Each synthesis filter corresponds to a respective subband, and is applied to the interference mitigated, upsampled, subband data in the fast-time dimension to enable recombination of the subbands, thereby reconstructing the original frequency bandwidth of the data stored in the Sensor Data Buffer 21. The synthesis filters may be applied using prior art techniques such as time-domain convolution or frequency-domain multiplication. The synthesis filtered, interference mitigated data, corresponding to each subband, can be integrated to reconstruct an interference mitigated data product with the original frequency bandwidth of the data stored in the Sensor Data Buffer 21. FIG. 24 illustrates the subband architecture with analysis, downsampling, interference mitigation, upsampling, and synthesis of interference mitigated subbands being applied.

Each adaptation-variant device differs by its method of determining and applying interference-mitigation:
1. Adaptation Antenna Element device 31 can perform data adaptive statistical estimation of interference signals, compute a finite sample covariance matrix of interference signals and noise across the spatial dimension, and compute either a sample matrix inverse (SMI) of the covariance matrix or an orthogonal complement projection derived from eigenvectors of the covariance matrix.
2. Subspace Projection Device 32 can apply orthogonal complement projections constructed directly from fast-time samples across the spatial dimension of the data, optionally constrained by a spatial-gradient to enlarge the null space of the projection.
3. Deterministic Filter Device 33 can employ predefined filter operators in one or more domains (time, frequency, space, or wavenumber) to attenuate known interference bands or spatial sectors.

The Adaptation Antenna Element Device 31 can be configured to compute the finite sample covariance matrix of interference and noise across the spatial dimension of the data stored in the Sensor Data Buffer 31. The finite sample covariance matrix may be computed using fast-time samples as training samples. The Adaptation Antenna Element Device 31 can use many conventional techniques to compute the finite sample covariance matrix from training samples. Additionally, numerous conventional techniques can be applied to select the training samples. In some embodiments, the Adaptation Antenna Element Device 31 may “diagonal load” the covariance matrix to ensure numerical stability of inverse operations. The diagonal loading operation can be performed by adding a scaled identity matrix to the finite sample covariance matrix. The scalar factor applied to the identity matrix may be predefined. As shown in FIG. 2, the Adaptation Antenna Element Device 31, in some embodiments, uses a Sample Matrix Inversion (SMI) 31a technique on the diagonal loaded finite sample covariance matrix to calculate a precision matrix. The Sample Matrix Inversion (SMI) 31a technique can complex multiply the precision matrix by the spatial dimension for all, or a subset of, fast-time or frequency samples of data in the Adaptation Data Buffer 22. FIGS. 11, 20 illustrate interference mitigated image data displayed by the Image Display Device (or Image Processing Computer) 50 when the Adaptation Antenna Element Device 31 uses the SMI 31a technique to mitigate interference signals in both the near-field and far-field of the Sensor Array 10.

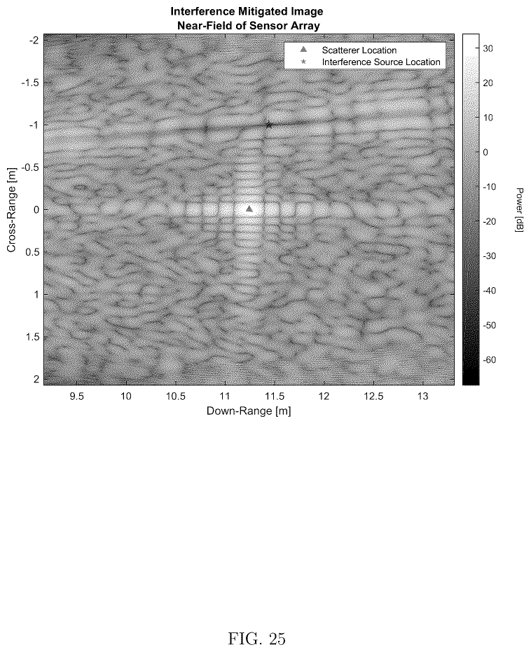

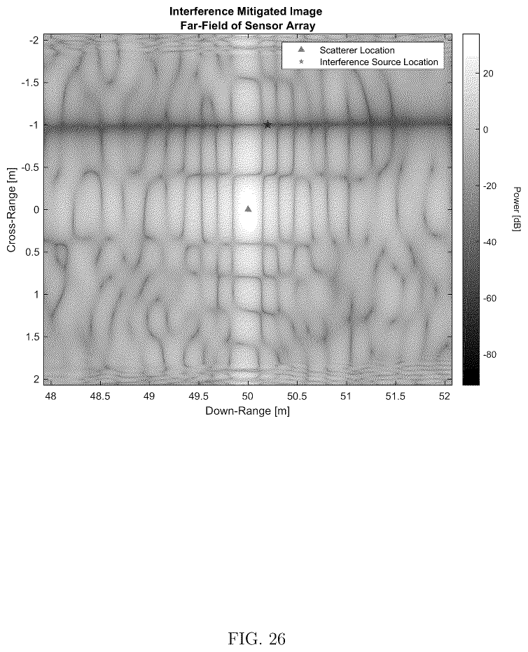

As illustrated in FIG. 2, the Adaptation Antenna Element Device 31, in some embodiments, uses an Eigenvector Orthogonal Complement Projection 31b technique. The Eigenvector Orthogonal Complement Projection 31b technique uses eigenvectors of the finite sample covariance matrix to form an orthogonal complement projection matrix to the interference signal subspace. The Eigenvector Orthogonal Complement Projection 31b technique can complex multiply the orthogonal complement projection matrix by the spatial dimension for all, or a subset of, fast-time or frequency samples of the subband data stored in the Adaptation Data Buffer 22. Various conventional techniques can be used to select eigenvectors of the finite sample covariance matrix that correspond to the interference signal subspace. FIG. 25-26 illustrate interference mitigated image data displayed by the Image Display Device (or Image Processing Computer) 50 when the Adaptation Antenna Element Device 31 uses the Eigenvector Orthogonal Complement Projection 31b technique to mitigate interference signals in both the near-field and far-field of the Sensor Array 10.

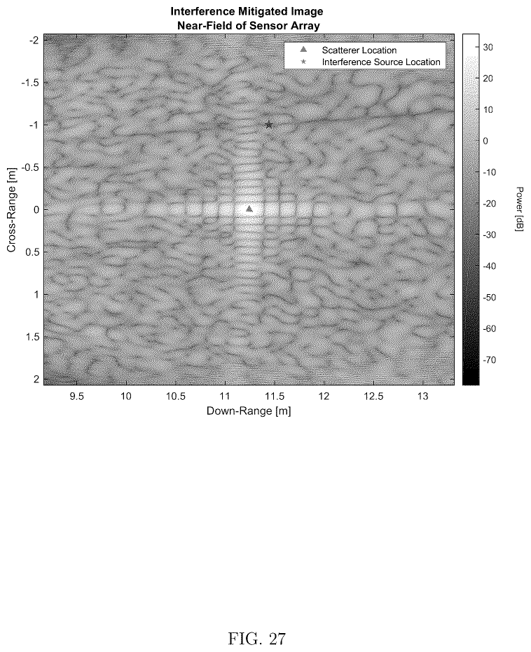

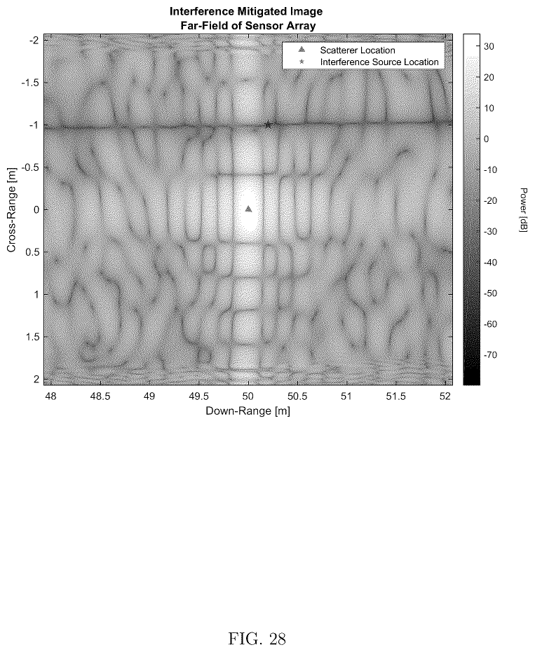

As illustrated in FIG. 2, the Subspace Projection Device 32, in some embodiments, uses an Orthogonal Complement Projection 32a technique to mitigate interference signals. The Orthogonal Complement Projection 32a technique can compute an orthogonal complement projection to the interference signal subspace by using fast-time samples of the subband data, corresponding to interference signals, as training samples. Numerous conventional approaches can be applied to select the training samples. The Orthogonal Complement Projection 32a technique may employ various conventional techniques to calculate the orthogonal complement projection. The Orthogonal Complement Projection 32a technique can then complex multiply the orthogonal complement projection by the spatial dimension for all, or a subset of, fast-time or frequency samples of the data in the Adaptation Data Buffer 22. FIG. 27-28 illustrates interference mitigated image data displayed by the Image Display Device (or Image Processing Computer) 50 when the Subspace Projection Device 32 uses the Orthogonal Complement Projection 32a technique to mitigate interference signals in both the near-field and far-field of the Sensor Array 10.

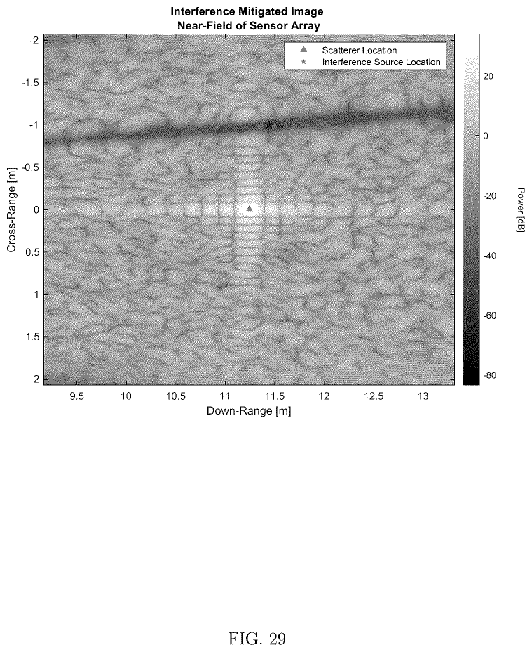

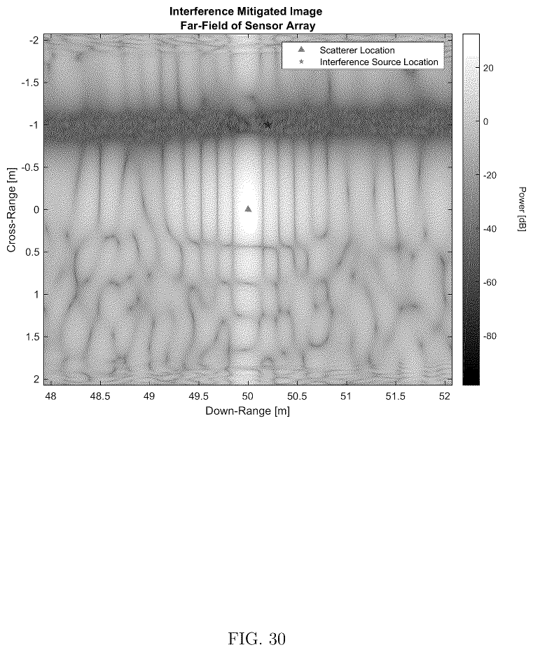

As illustrated in FIG. 2, the Subspace Projection Device 32, in some embodiments, uses an Orthogonal Complement Projections with Gradient Constraint 32b technique to mitigate interference signals. The Orthogonal Complement Projections with Gradient Constraint 32b technique can shrink the subspace spanned by the orthogonal complement projection matrix by employment of a gradient constraint during construction. This smaller subspace of the orthogonal complement projection can mitigate a larger number of interference signals arriving at the Sensor Array 10 within the field of view compared to orthogonal complement projections that do not include the gradient constraint. As an example, a one-dimensional Sensor Array 10 with uniformly spaced Digital Sensor Elements 11 may employ a diagonal matrix with the diagonal entries corresponding to the cross-range spatial position of each Digital Sensor Element 11 of the Sensor Array 10 with respect to the field of view. The result is termed a “spatial matrix”. The Orthogonal Complement Projections with Gradient Constraint 32b technique may multiply the spatial matrix by the training samples. The Orthogonal Complement Projections with Gradient Constraint 32b technique can generate a column partitioned matrix with each block composed of polynomials of the spatial matrix multiplied by the training samples. A polynomial of the spatial matrix implies the spatial matrix multiplied by itself a given number of times. As an example, a third-order polynomial of the spatial matrix would mean the spatial matrix is multiplied by itself three times. The column partitioned matrix is constructed such that, in each block, the polynomials are sequentially increasing in order with respect to the index of the block. The column partitioned matrix uses a zero-order polynomial of the spatial matrix (i.e., the identity matrix) for the first block. A larger number of polynomials will further shrink the subspace of the orthogonal complement projection. The number of polynomials used during construction of the column partitioned matrix may be predefined. The Orthogonal Complement Projections with Gradient Constraint 32b technique can calculate an orthogonal complement projection to the subspace spanned by the column partitioned matrix. The Orthogonal Complement Projections with Gradient Constraint 32b technique can complex multiply the orthogonal complement projection by the spatial dimension for all, or a subset of, fast-time or frequency samples of the data in the Adaptation Data Buffer 22, resulting in interference mitigated data. FIG. 29-30 illustrate interference mitigated image data displayed by the Image Display Device (or Image Processing Computer) 50 when the Subspace Projection Device 32 uses the Orthogonal Complement Projections with Gradient Constraint 32b technique to mitigate interference signals in both the near-field and far-field of the Sensor Array 10.

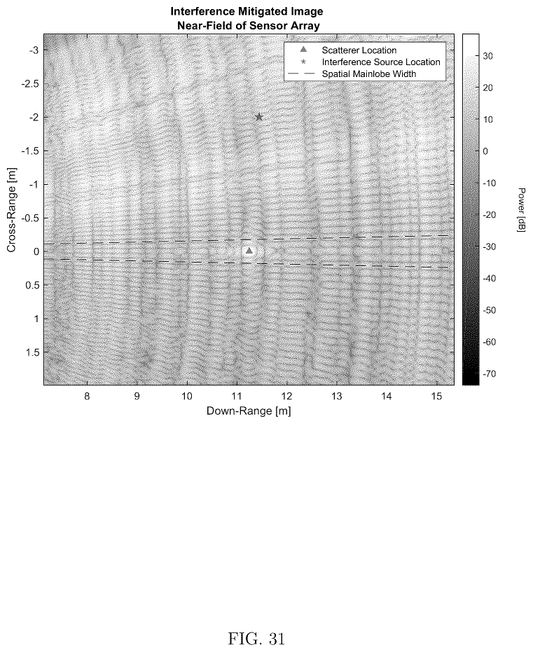

In some embodiments, the Deterministic Filter Device 33 applies predefined filters to all, or a subset of, samples in the fast-time, frequency, spatial, or wavenumber domain/dimension of the data to mitigate interference signals. The predefined filters may be representative of notch filters, low-pass filters, high-pass filters, bandpass filters, or some other variant. The predefined filters may be applied by conventional convolutional (or frequency domain elementwise multiplication, when appropriate) techniques to the data stored in the Adaptation Data Buffer 22. FIG. 31 illustrates interference mitigated image data displayed by the Image Display Device (or Image Processing Computer) 50 when mitigating interference using this approach.

Following mitigation, all variants can perform identical conditioning steps, including zero-padding, domain transformation, and storage—to maintain a consistent data format for storage in the Rectilinear Frequency Wavenumber Data Buffer 23. Subsequent stages of the pipeline (replica generation, Inverse Huygens-Fresnel Transfer, and wavenumber migration) operate identically regardless of the Adaptation-Variant Device.

In some embodiments, the adaptation-variant device zero-pads the spatial samples of the interference mitigated data such that the number of spatial samples corresponds to the number of samples, pixels, and/or voxels in the corresponding dimension of the interference mitigated image, as illustrated in FIG. 23. Post zero-padding, the adaptation variant device can execute a Discrete Fourier Transform (DFT) to the relevant dimensions of the zero-padded, interference mitigated data such that it is in the frequency and wavenumber domain. The adaptation variant device may store the zero-padded, interference mitigated data in the frequency and wavenumber domain in the Rectilinear Frequency Wavenumber Data Buffer 23 for subsequent processing by the Processor 40.

### Fresnel-Based Imaging Pipeline

The Processor 40, as described herein, can perform nearly identical steps as prior art Fresnel-based imaging pipelines, with adjustments made to account for interference mitigated data products. The descriptions of the operations performed by the Processor 40 are described in detail to illustrate adjustments that can be made to account for interference mitigated data generated by the Adaptation Device 30.

In some embodiments, the Processor 40 determines a spatial reference point for the location of both the Sensor Array 10 and the field of view. The Processor 40 can execute a Sensor Reference Point Evaluation 42, which identifies the location of the spatial centroid of the Sensor Array 10 as well as a nominal center point location of the field of view. For operating scenarios that include integration of multiple single pulse images generated by a mobile Sensor Array 10 as it traverses a predetermined path (or multiple systems looking at a stationary field of view), the Sensor Reference Point Evaluation 42 may change the location of the spatial centroid of the Sensor Array 10 while maintaining the nominal center point location of the field of view (as is done in “synthetic aperture radar” systems). Alternatively, there may be scenarios where the Sensor Array 10 is kept stationary and the Sensor Reference Point Evaluation 42 may adjust the nominal center point location of a mobile field of view (as done in “inverse synthetic aperture radar” systems). The spatial reference point of both the Sensor Array 10 and the field of view may be determined by position and motion tracking systems. Examples of position and motion tracking systems typically used in airborne or automotive synthetic array radar systems include, but are not limited to, odometers, inertial measurement units, and global positioning systems.

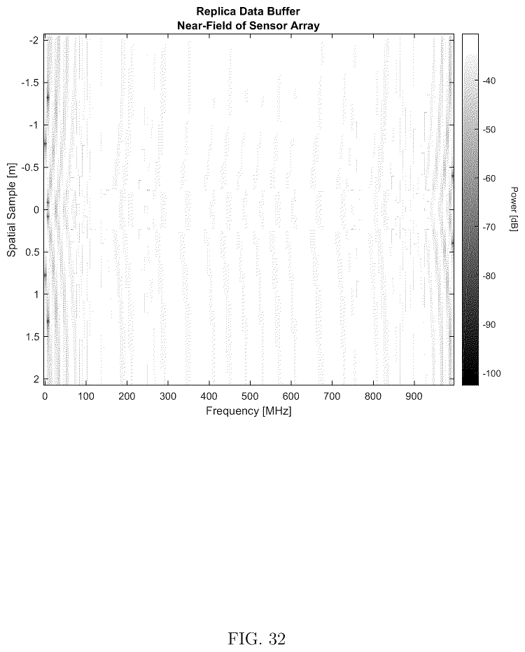

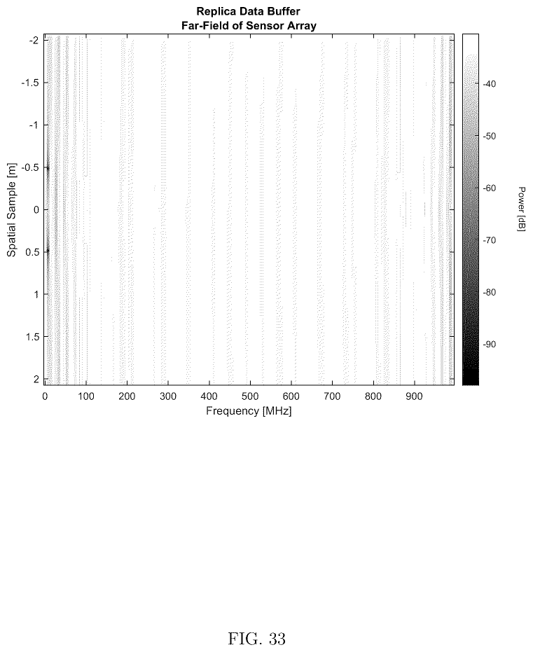

In some embodiments, the Processor 40 executes Fresnel Field Replica Generation 44 to create an intermediate data product termed a “replica”, which models a reference Fresnel field and accounts for the distance between the spatial points of both the centroid of the Sensor Array 10 and the field of view. Fresnel Field Replica Generation 44 models transmission, propagation, reflection, and reception of a reference Fresnel field. Transmission of the waveform may be modeled as originating from the centroid of the Sensor Array 10, or from some other nominal spatial point. Propagation may model the reference Fresnel field as it travels the distance between the reference transmit point(s) and the reference spatial position of the field of view. The reflection point may be representative of a simulated isotropic scatterer located at the reference spatial position of the field of view. A second form of propagation of the simulated Fresnel field may be modeled from the simulated isotropic scatterer location to one or multiple “receive locations”. The receive locations can correspond, at a minimum, to the reference spatial locations of the Digital Sensor Elements 11 of the Sensor Array 10. The receive locations may be termed “simulated spatial samples”. Alternatively, the Processor 40 may account for additional simulated spatial sample positions that extend beyond the width of the Sensor Array 10 up to and including the full cross-range width (and/or height) of the field of view. The spatial distance between the simulated spatial samples may be proportional to, including possibly equal to, the predefined spacing of the Digital Sensor Elements 11 of the Sensor Array 10. The total number of simulated spatial samples may correspond to the pixels in the cross-range and/or height dimension of the image data corresponding to the field of view. If the total number of simulated spatial samples is less than the number of pixels in the cross-range and/or height dimension of the image data corresponding to the field of view, then the Processor 40 may zero-pad both ends of the spatial dimension of the replica such that the total number of spatial samples is equivalent to the number of pixels in the cross-range and/or height dimension of the image data corresponding to the field of view. Fresnel Field Replica Generation 44 may use the transmitted waveform as a template to model outward Fresnel wave field propagation when generating the replica. Fresnel Field Replica Generation 44 may use multiple monochromatic spatial isotropic sinusoidal wave fields to model a possibly polychromatic transmitted waveform. The Processor 40 can generate a data buffer termed the “Replica Data Buffer 24” to store the replica generated by Fresnel Field Replica Generation 44. FIG. 32-33 illustrate examples of replica data stored in the Replica Data Buffer 24 for both the near-field and far-field of the Sensor Array 10.

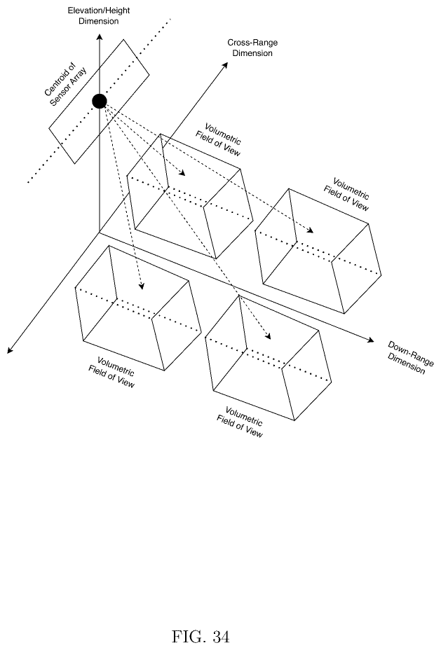

In some embodiments, the Processor 40 determines spatial reference points for one or more distinct fields of view. Each distinct field of view may not overlap, spatially, with any other field of view. The Processor 40 may generate distinct replicas for each field of view and store them in distinct Replica Data Buffers 24. FIG. 34 illustrates multiple distinct volumetric fields of view with their bounds and spatial reference point of the centroid of the Sensor Array 10. As an example, sensor arrays used for sonar purposes may generate multiple volumetric images of distinct fields of view such that the System 1 is able to image its surrounding environment.

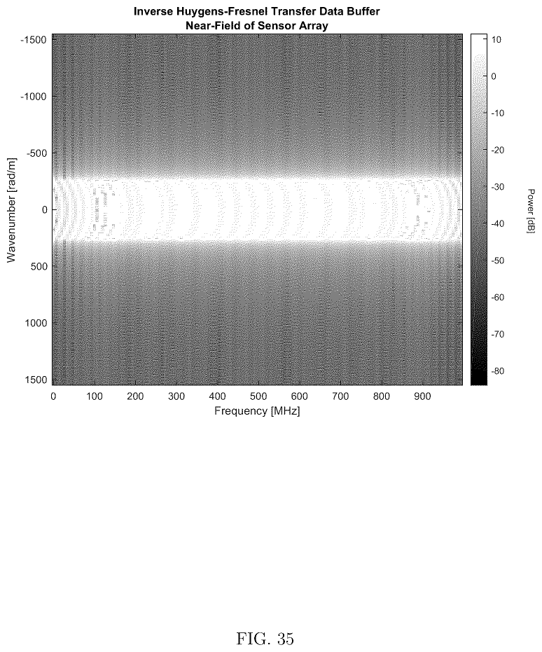

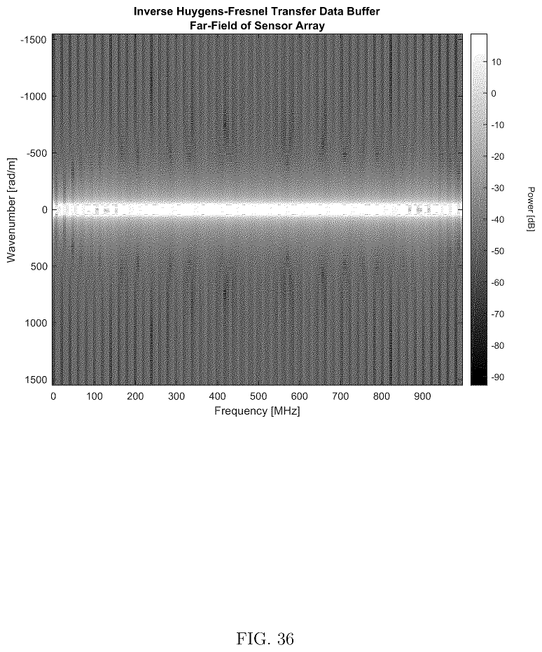

In some embodiments, the Processor 40 performs a Discrete Fourier Transform (DFT) to the spatial dimension of the replicas stored in the replica data buffers 24. The DFT can convert the spatial dimension of the replica to the wavenumber domain, and convert the reference Fresnel field to a reference Huygens-Fresnel transfer. The Processor 40 can perform a complex conjugation on each sample of each reference Huygens-Fresnel transfer to form inverse Huygens-Fresnel transfers. The Processor 40 can generate and store each inverse Huygens-Fresnel transfer in a data buffer termed the Inverse Huygens-Fresnel Transfer Data Buffer 25. FIG. 35-36 illustrate Inverse Huygens-Fresnel Transfer Data Buffer 25 contents in the near-field and far-field of the Sensor Array 10. The complex conjugation used to generate the inverse Huygens-Fresnel transfer can invert the wave field in the frequency and wavenumber domain, allowing reconstruction of an image in a coordinate system centered on the spatial reference point of the field of view.

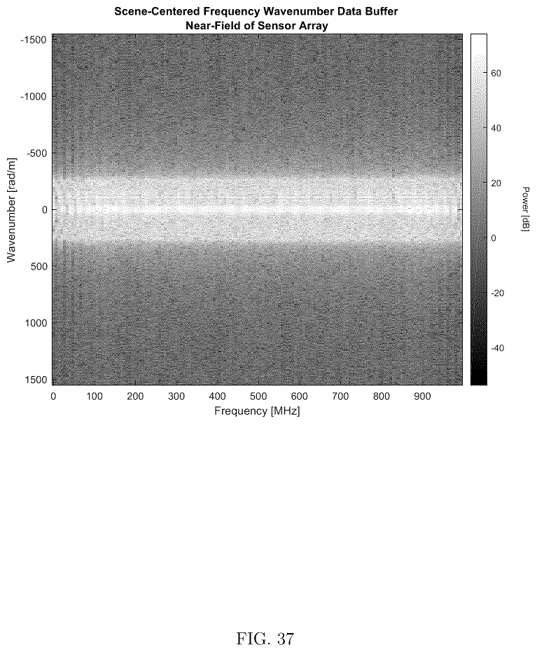

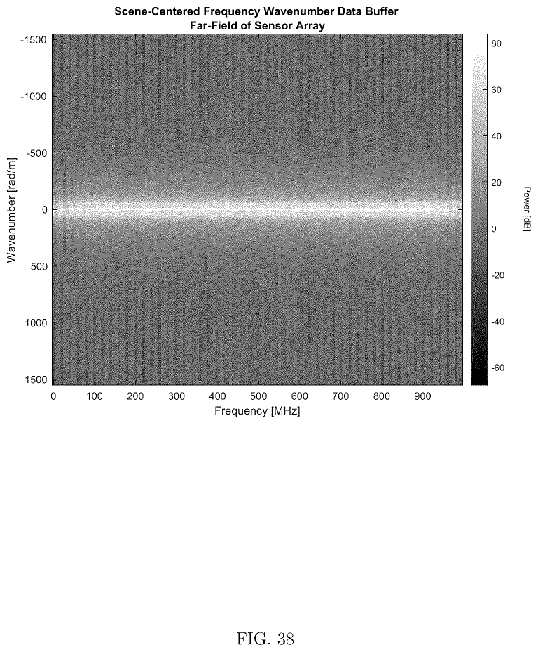

In some embodiments, the Processor 40 complex multiplies each element of the data in the Rectilinear Frequency Wavenumber Data Buffer 23 by each corresponding element of the data in the Inverse Huygens-Fresnel Transfer Data Buffer 25. The complex elementwise multiplication can serve multiple purposes. As far as its impact on the signal, the complex elementwise multiplication can serve the purpose of pulse compression in prior art sensor array signal processing techniques. Pulse compression can effectively increase Signal-to-Noise-Ratio (SNR) of a signal and, depending on the waveform, improve the resolution of the Point Spread Function (PSF). Additionally, the complex elementwise multiplication can invert the wavefield such that the sinusoidal components of the signal in the frequency and wavenumber domain are referenced with respect to the spatial reference point of the field of view as the origin rather than the centroid of the Sensor Array 10. The Processor 40 can generate and store the results of the complex elementwise multiplication of the data in the Rectilinear Frequency Wavenumber Data Buffer 23 and the Inverse Huygens-Fresnel Transfer Data Buffer 25 in a data buffer termed the Scene-Centered Frequency Wavenumber Data Buffer 26. FIG. 37-38 illustrate Scene-Centered Frequency Wavenumber Data Buffer 26 contents in the near-field and far-field of the Sensor Array 10.

In some embodiments, the Processor 40 executes Wavenumber Remapping 46 on the frequency dimension of the data stored in the Scene-Centered Frequency Wavenumber Data Buffer 26. Wavenumber Remapping 46 can convert the frequency domain of the data into an angular spectrum by Stolt formatting. Samples of the angular spectrum may be nonuniformly spaced in the down-range wavenumber domain. The Processor 40 can generate and store the results of Wavenumber Remapping 46 in the Angular Spectrum Data Buffer 27. As an example, data in the Scene-Centered Frequency Wavenumber Data Buffer 26 may be one-dimensional and data in the Angular Spectrum Data Buffer 27 may be two-dimensional (required by conventional Stolt formatting).

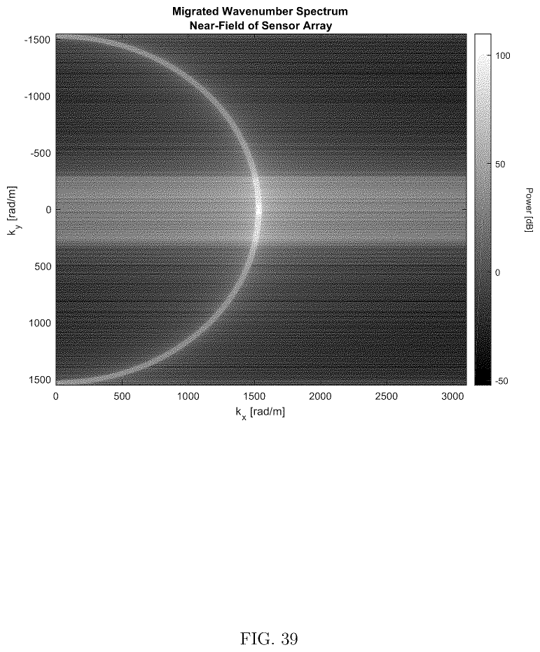

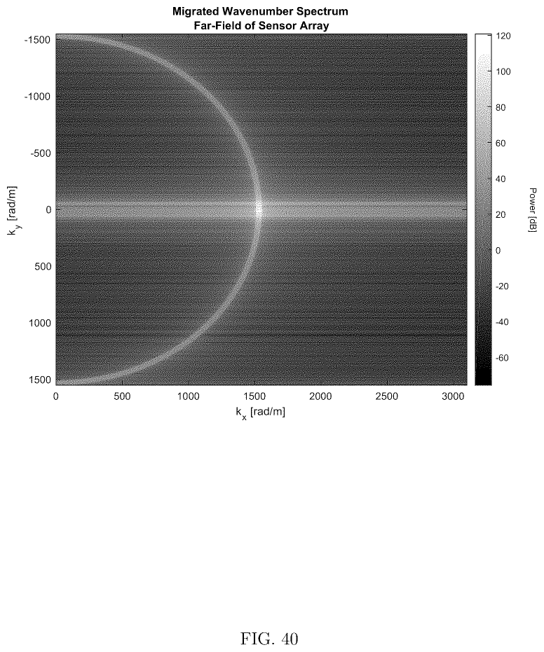

In some embodiments, the Processor 40 executes Wavenumber Migration 48 on the data stored in the Angular Spectrum Data Buffer 27. Wavenumber Migration 48 resamples elements of the data stored in the Angular Spectrum Data Buffer 27 uniformly to create a Fourier transform invertible spectrum of the field of view image. The output of Wavenumber Migration 48 can be an image spectrum with uniformly spaced wavenumber samples in the down-range, cross-range, and/or height dimension of the image data corresponding to the field of view. FIG. 39-40 illustrate the results of Wavenumber Migration 48 corresponding to data products in the near-field and far-field of the Sensor Array 10. The Processor 40 can perform an Inverse Discrete Fourier Transform (IDFT) to each dimension of the uniformly sampled wavenumber samples resulting in an interference mitigated image data product. The Processor 40 can generate and store the results of the multidimensional IDFT in the Interference Mitigated Image Data Buffer 28.

The disclosed technology can be utilized to replace single pulse Fresnel-based imaging pipelines used by prior art with an interference mitigation architecture capable of imaging a field of view in contested sensing environments. Embodiments of the disclosed technology can provide an imaging alternative to conventional adaptive Fraunhofer plane-wave based beamforming that is able to mitigate interference in only the far-field of the Sensor Array 10. Embodiments of the disclosed technology can overcome the limitations of prior art sensor array processing to provide interference mitigated one-dimensional, two-dimensional, or three-dimensional imaging capacity in a (possibly) expanded field of view relative to the Sensor Array 10. Embodiments of the disclosed technology can implement one or more of the following features.

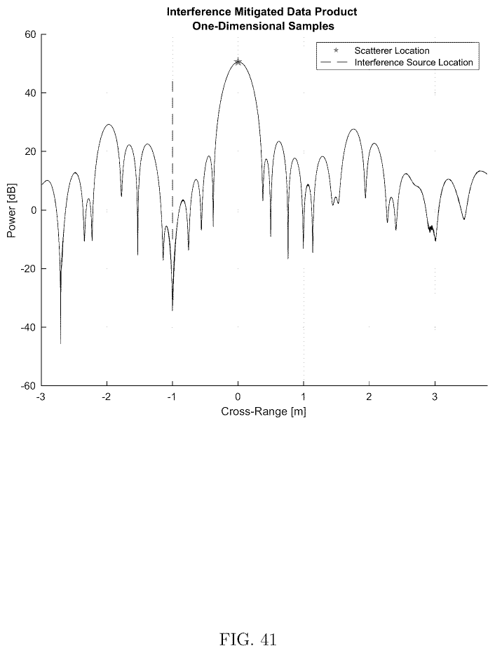

First, some embodiments of the disclosed technology provide an interference mitigation capability, allowing the System 1 to image contents of the field of view for the near-field and/or far-field of the Sensor Array 10 within contested sensing environments. Some embodiments of the disclosed technology preserve second (or higher) order characteristics of outwardly propagating wavefields in interference mitigated data required for single-pulse imaging techniques such that integration of complex image data generated from spatially diverse positions of a Sensor Array 10 to the field of view improves scatterer point spread function resolution compared to single pulse image data. FIGS. 18, 41 depict improved resolution of a scatterer point spread function when integrating interference mitigated, complex, image data corresponding to a stationary field of view and mobile Sensor Array 10. Some embodiments of the disclosed technology estimate statistics of interference, generate orthogonal complement projections, and/or employ predefined filters to mitigate interference signals. Statistical estimates of interference signals can be used to construct covariance matrices of interference and noise which can be used to calculate covariance matrix inverses and/or complement orthogonal projections to eigenvectors of an interference subspace. Orthogonal complement projections use fast-time training samples with an optional gradient constraint to project data onto a subspace orthogonal to that of the interference signal. Predefined filters may apply broad nulls to the data to mitigate interference signals. Some embodiments of the disclosed technology perform a Discrete Fourier Transform (DFT) to the relevant fast-time and/or spatial samples (if applicable) of the interference mitigated data such that it is in the frequency-wavenumber domain.

Second, some embodiments of the disclosed technology use prior art Fresnel-based imaging techniques to create an expanded, isotropic, reference, monochromatic or polychromatic, Fresnel wave field which may model outward propagating electromagnetic or acoustic fields that span the distance between the Sensor Array 10 and a field of view to be imaged. Some embodiments of the disclosed technology create a frequency-wavenumber inversion operator by applying a complex conjugation to the Fourier transform of the spatial dimensions of the reference Fresnel wave field, with the resulting data product termed the Inverse Huygens-Fresnel Transfer (IHFT). Some embodiments of the disclosed technology perform conventional pulse compression as well as inversion of sinusoidal content of frequency-wavenumber data products to a scene-centered coordinate system by elementwise complex multiplication of interference mitigated data in the frequency-wavenumber domain by the IHFT. Some embodiments of the disclosed technology convert the inverted rectilinear frequency-wavenumber data to the angular spectrum by Wavenumber Migration 48, resulting in nonuniformly sampled down-range wavenumber content of the generated data product. Some embodiments of the disclosed technology resample the angular spectrum such that wavenumber samples corresponding to the down-range, cross-range, and height dimensions are uniformly sampled, resulting in an image spectrum. Some embodiments of the disclosed technology apply an inverse Fourier transform to each spectrum dimension of the data to create a one-dimensional, two-dimensional, or three-dimensional image of the contents of the sensed field of view with interference mitigated.

Third, some embodiments of the disclosed technology integrate single-pulse, complex, interference mitigated, image data generated by the System 1 from different spatial positions of a Sensor Array 10 for a field of view to improve the Signal-to-Interference-plus-Noise-Ratio (SINR) and resolution of scatterer point spread functions.

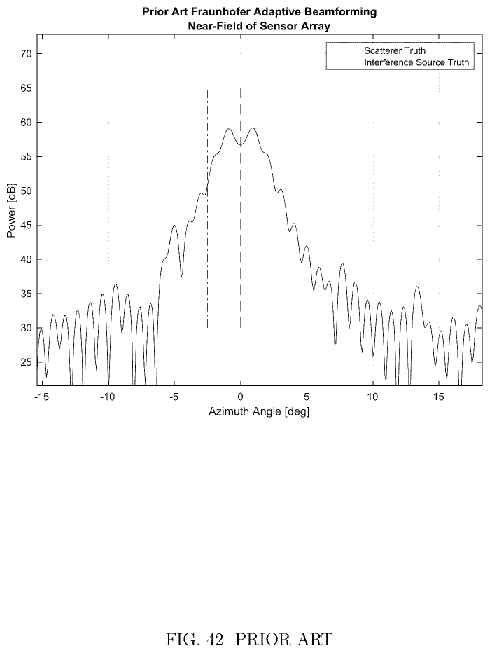

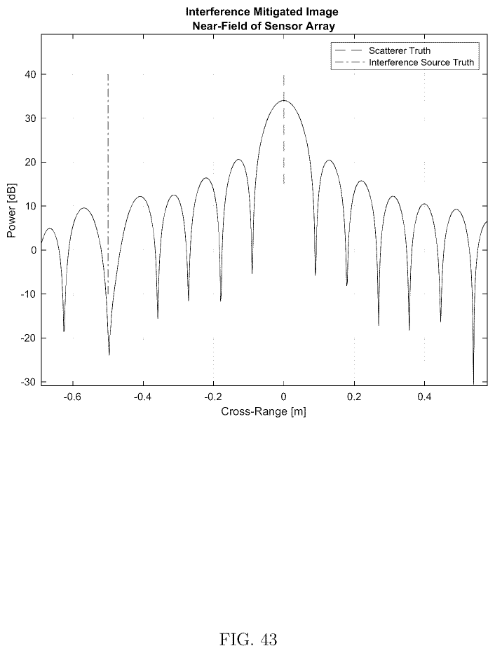

FIG. 42 illustrates realm of failure of prior art Fraunhofer interference mitigation techniques in the near-field of the Sensor Array 10 with a uniform linear sensor array. FIG. 42 illustrates bias in Angle-of-Arrival (AoA) estimation of echoes reflected by scatterers compared to an interference-free sensing environment when using prior art Fraunhofer interference mitigation techniques in the near-field of the Sensor Array 10. By contrast, FIG. 43 illustrates success of an embodiment of the disclosed technology in resolving scatterer location, with no bias, when mitigating interference that falls within the spatial mainlobe of Fraunhofer plane wave beams.

FIGS. 12, 21 illustrate realm of failure of prior art single pulse, Fresnel-based, imaging pipeline techniques to mitigate interference when generating image data products in the near-field and far-field of the Sensor Array 10 with a uniform linear sensor array. FIGS. 12, 21 illustrate insufficient Signal-to-Interference-plus-Noise-Ratio (SINR) of echoes reflected by scatterers within the field of view compared to an interference-free sensing environment. By contrast, FIGS. 11, 20 illustrate success of embodiments of the disclosed technology in mitigating interference in the near-field and far-field of the Sensor Array 10, as well as increasing SINR.

Embodiments of the present disclosure find many applications, including, but not limited to: radar sensor arrays for self-driving cars that need to mitigate interference arising from other nearby deployed vehicles; radar sensor arrays for surveillance of airplane traffic control system that need to mitigate interference arising from cell sites, satellite communications, or other civilian radiofrequency infrastructure; radar sensor arrays for defense/military applications where systems need to mitigate interference arising from intentional jamming; sonar sensor arrays, seismic sensor arrays, and ultrasonic medical imaging devices, among many other possibilities, that need to mitigate interference arising from a plenitude of sources. Additionally, embodiments of the present disclosure may support multiple-input/multiple-output (MIMO) array communication within Fifth Generation (5G) Long-Term Evolution (LTE) architectures. Embodiments of the present disclosure may further enable base stations to apply imaging-based array processing to estimate the spatial positions of Internet-of-Things (IoT) transmitters or other devices within the observable field of the array.

As those skilled in the art would appreciate, the various components and their functions disclosed herein can be implemented in combinations of hardware and/or software. For example, in some embodiments, the adaptation and processing operations are executed as software modules stored in the Computer Readable Medium 20 and executed by a processing device. In some embodiments, latency-sensitive steps, such as sample matrix inversion and finite sample covariance matrix estimation, are implemented in dedicated digital signal processing hardware or field-programmable gate arrays (FPGAs) coupled to the Adaptation Device 30, or Processor 40, to accelerate real-time performance.

Certain implementations of the disclosed technology are described above with reference to block and flow diagrams of systems and methods and/or computer program products according to example implementations of the disclosed technology. It will be understood that one or more blocks of the block diagrams and flow diagrams and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some implementations of the disclosed technology.

These computer program instructions may also be stored in a computer readable memory that can direct a computer or other programmable data processing apparatus to function in a particular manner, such that the instructions stored in the computer-readable memory produce an article of manufacture including instruction means that implement one or more functions specified in the flow diagram block or blocks.

Implementations of the disclosed technology may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

1. A system for generating interference-mitigated images of a scene within a sensed field of view, comprising:
a sensor array comprising a plurality of sensor elements configured to transmit a waveform and receive corresponding echo and interference signals;
an adaptation device configured to receive data acquired by the sensor array, estimate or determine characteristics of interference within the received data, and mitigate the interference to generate interference-mitigated data; and
a processor configured to reconstruct one-dimensional, two-dimensional, or three-dimensional images of the sensed field of view by performing Fresnel-based imaging operations on the interference-mitigated data,
wherein the data acquired by the sensor array is from transmission of a single pulse or a plurality of pulses, or corresponds to motion of the sensor array.

2. The system of claim 1, wherein the sensor array comprises a plurality of digital sensor elements having uniform or non-uniform spatial spacing, each configured to record digital samples synchronized in time and frequency.

3. The system of claim 1, wherein the adaptation device is configured to partition a frequency bandwidth of the digital data into a plurality of subbands, mitigate interference within each subband, and recombine the plurality of subbands to form the interference-mitigated data.

4. The system of claim 3, wherein the adaptation device is configured to apply analysis filters to form the plurality of subbands, perform interference mitigation within each subband, and apply synthesis filters to reconstruct a full-bandwidth signal.

5. The system of claim 1, wherein the adaptation device comprises an adaptation antenna element device configured to compute a finite-sample covariance matrix of interference and noise across a spatial dimension of the data acquired by the sensor array, and to mitigate interference using at least one of a sample-matrix inversion and an orthogonal-complement projection derived from eigenvectors of the covariance matrix.

6. The system of claim 1, wherein the adaptation device comprises a subspace projection device configured to construct an orthogonal-complement projection from fast-time training samples, optionally constrained by a spatial-gradient term that enlarges a null space to suppress interference within the field of view.

7. The system of claim 1, wherein the adaptation device comprises a deterministic filter device configured to apply predefined filters in one or more domains selected from the group consisting of time, frequency, spatial, and wavenumber domains, to attenuate predetermined interference bands or spatial sectors.

8. The system of claim 1, wherein the adaptation device is configured to apply zero-padding to spatial samples of the interference-mitigated data, perform Discrete Fourier Transforms to relevant dimensions of the zero-padded, interference mitigated data, and to store the result in a frequency-wavenumber domain for processing by the processor.

9. The system of claim 1, wherein the processor is configured to:
determine spatial reference points for the sensor array and the field of view;
generate reference Fresnel field replicas representing modeled propagation between the sensor array and the field of view;
compute inverse Huygens-Fresnel transfers by complex conjugation of Fourier-transformed replicas;
perform elementwise complex multiplication of the interference-mitigated data in the frequency and wavenumber domain with the inverse Huygens-Fresnel transfers to generate scene-centered frequency-wavenumber data;
perform wavenumber remapping to produce an angular spectrum; and
execute wavenumber migration and inverse Fourier transformation to form an interference-mitigated image of the field of view.

10. The system of claim 9, wherein the processor is further configured to integrate interference mitigated image data generated from multiple pulses corresponding to multiple spatial positions of the sensor array to enhance scatterer point-spread-function resolution, Signal-to-Noise-Ratio, and Signal-to-Interference-plus-Noise-Ratio.

11. A method for generating an interference-mitigated image of a scene within a sensed field of view, comprising:
transmitting, by a plurality of sensor elements of a sensor array, a waveform toward the field of view;
receiving, by the plurality of sensor elements, corresponding echo and interference signals;
storing data representative of the received signals;
mitigating interference within the data using an adaptation device configured to perform statistical estimation, subspace projection, or deterministic filtering of the data; and
reconstructing an image of the field of view by performing one or more Fresnel-based imaging operations selected from the group consisting of: replica generation; inverse Huygens-Fresnel transformation; and wavenumber migration.

12. The method of claim 11, further comprising integrating interference mitigated image data generated from multiple spatial positions of the sensor array to enhance scatterer point-spread-function resolution.

13. The method of claim 11, wherein mitigating interference comprises computing a finite-sample covariance matrix of interference and noise across a spatial dimension of the data representative of the received signals and applying sample-matrix inversion or orthogonal-complement projection derived from eigenvectors of the covariance matrix.

14. The method of claim 13, wherein mitigating interference comprises applying orthogonal-complement projection derived from eigenvectors of the covariance matrix, and wherein the orthogonal-complement projection is constrained by a spatial-gradient term that enlarges a null space to suppress interference within the field of view.

15. The method of claim 11, wherein mitigating interference comprises partitioning frequency bandwidth of the data into a plurality of subbands, applying interference mitigation within each of the plurality of subbands, and recombining the plurality of subbands.

16. The method of claim 15, wherein partitioning comprises applying analysis filters to form the plurality of subbands and applying synthesis filters to reconstruct a full-bandwidth signal after interference mitigation.

17. A non-transitory computer-readable medium storing instructions that, when executed by one or more processors, cause the one or more processors to perform operations comprising:
receiving digital data acquired by a sensor array;
mitigating interference in the data using statistical, subspace, or deterministic filtering operations;
generating reference Fresnel field data and corresponding inverse Huygens-Fresnel transfers;
performing wavenumber remapping and migration; and
reconstructing an interference-mitigated image of a sensed field of view based on the mitigated data.

18. The non-transitory computer-readable medium of claim 17, wherein mitigating interference comprises computing a finite-sample covariance matrix of interference and noise across a spatial dimension of the received data and applying sample-matrix inversion or orthogonal-complement projection derived from eigenvectors of the covariance matrix.

19. The non-transitory computer-readable medium of claim 18, wherein mitigating interference comprises applying orthogonal-complement projection derived from eigenvectors of the covariance matrix.

20. The non-transitory computer-readable medium of claim 17, wherein the operations further comprise integrating interference mitigated image data generated from multiple spatial positions of the sensor array to enhance scatterer point-spread-function resolution, Signal-to-Noise-Ratio, and Signal-to-Interference-plus-Noise-Ratio.
